(19) United States
(12) Patent Application Publication
(10) Pub. No.: US 2022/0051104 A1
(43) Pub. Date: Feb. 17, 2022

(54) ACCELERATING INFERENCE OF TRADITIONAL ML PIPELINES WITH NEURAL NETWORK FRAMEWORKS

(71) Applicant: Microsoft Technology Licensing, LLC, Redmond, WA (US)

(72) Inventors: Matteo INTERLANDI, Seattle, WA (US); Markus WEIMER, Kirkland, WA (US); Saeed AMIZADEH, Seattle, WA (US); Konstantinos KARANASOS, San Francisco, CA (US); Supun Chathuranga NAKANDALA, La Jolla, CA (US); Karla J. SAUR, Seattle, WA (US); Carlo Aldo CURINO, Woodinville, WA (US); Gyeongin YU, Seoul (KR)

(21) Appl. No.: 16/993,900

(22) Filed: Aug. 14, 2020

(51) Int. Cl. G06N 3/08; G06N 3/04; G06N 20/20; G06N 5/00

(52) U.S. Cl. CPC G06N 3/084; G06N 5/003; G06N 20/20; G06N 3/0454

(57) ABSTRACT

Methods, systems, and computer program products are provided for generating a neural network model. A ML pipeline parser is configured to identify a set of ML operators for a previously trained ML pipeline, and map the set of ML operators to a set of neural network operators. The ML pipeline parser generates a first neural network representation using the set of neural network operators. A neural network optimizer is configured to perform an optimization on the first neural network representation to generate a second neural network representation. A tensor set provider outputs a set of tensor operations based on the second neural network representation for execution on a neural network framework. In this manner, a traditional ML pipeline can be converted into a neural network pipeline that may be executed on an appropriate framework, such as one that utilizes specialized hardware accelerators.

### BACKGROUND

Machine Learning (ML) infused applications are used across a variety of industries, including but not limited to business, manufacturing, science, computers, etc. Given the computational advantages, the use of ML continues to become more pervasive, and is expected to increase over time. Recent advances in technology have enabled other types of frameworks, such as Neural Network (NN) frameworks, which typically rely on more specialized hardware accelerators. Such NN frameworks, which may include Deep Neural Networks (DNNs), typically operate at an abstraction level of tensor operations, and are capable of executing arbitrary tensor computation graphs implemented in a suitable framework, and may additionally support different hardware backends.

However, despite such advantages, the majority of enterprises presently utilize classical ML-based approaches because they have large quantities of data stored in a tabular format, and classical ML techniques (e.g., linear models, tree ensemble methods, etc.) can be more effective for that type of data. For instance, data scientists may build ML model pipelines by composing data featurizers, feature selectors and ML models into Directed Acyclic Graphs (DAGs) of operators. Commonly, the same tools and systems used for training the model pipelines are used for prediction serving. Further, existing techniques where classical ML pipelines are implemented typically make it difficult to support end-to-end model deployment, optimizations, and execution on specialized hardware accelerators.

Further, model scoring (i.e., the process of presenting a trained model with new data to generate a prediction) can be an important factor for enterprise applications that rely on the generated predictions, such as instances where satisfactory latency and throughput are desired when scoring a model. In many instances, costs of model scoring can also be as great, or greater, than costs associated with training the model. In other words, models may be trained infrequently in an offline fashion in resource-rich or uniform cloud environments, but the same trained model may be scored many times and deployed in performance-critical, diverse environments.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for generating a neural network model. A ML pipeline parser is configured to identify a set of ML operators for a previously trained ML pipeline (e.g., comprising a traditional ML model), and map the set of ML operators to a set of neural network operators. The ML pipeline parser generates a first neural network representation using the set of neural network operators. A neural network optimizer is configured to perform an optimization on the first neural network representation to generate a second neural network representation. A tensor set provider outputs a set of tensor operations based on the second neural network representation for execution on a neural network framework. In this manner, a traditional ML pipeline can be converted into a neural network pipeline that may be executed on an appropriate framework, such as one that utilizes specialized hardware accelerators, which may improve performance during a scoring stage.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for converting a ML model to a neural network model, in accordance with an example embodiment.

FIG. 2 shows a flowchart of a method for generating a neural network model, in accordance with an example embodiment.

FIG. 3 shows a block diagram of a system for converting a ML model to a neural network model, in accordance with an example embodiment.

FIG. 4 shows a flowchart of a method for balancing a tree of a previously trained ML model, in accordance with an example embodiment.

FIG. 5 shows a flowchart of a method for generating a set of tensors based on a structure of a ML model, in accordance with an example embodiment.

FIG. 6 shows a flowchart of a method for performing an optimization on a set of tensor operations, in accordance with an example embodiment.

FIG. 7 shows a block diagram of a system for converting a ML model to a neural network model, in accordance with an example embodiment.

FIGS. 8A-8B show an illustrative conversion of a tree-based ML model, in accordance with an example embodiment.

FIGS. 9A-9B show another illustrative conversion of a tree-based model, in accordance with an example embodiment.

FIGS. 10A-10B show another illustrative conversion of a tree-based model, in accordance with an example embodiment.

FIG. 11 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous example embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

ML infused applications are used across a variety of industries, including but not limited to business, manufacturing, science, computers, etc. Given the computational advantages, the use of ML continues to become more pervasive, and is expected to increase over time. Recent advances in technology have enabled other types of frameworks, such as NN frameworks. Such NN frameworks, which may include DNNs, typically operate at an abstraction level of tensor operations, and are capable of executing arbitrary tensor computation graphs implemented in a suitable framework, and may additionally support different hardware backends.

However, despite such advantages, the majority of enterprises presently utilize classical ML-based approaches because they have large quantities of data stored in a tabular format, and classical ML techniques (e.g., linear models, tree ensemble methods, etc.) can be more effective for that type of data. For instance, data scientists may build ML model pipelines by composing data featurizers, feature selectors and ML models into DAGs of operators. Commonly, the same tools and systems used for training the model pipelines are used for prediction serving. Further, existing techniques where classical ML pipelines are implemented typically make it difficult to support end-to-end model deployment, optimizations, and execution on specialized hardware accelerators.

Further, model scoring (i.e., the process of presenting a trained model with new data to generate a prediction) can be an important factor for enterprise applications that rely on the generated predictions, such as instances where satisfactory latency and throughput are desired when scoring a model. In many instances, costs of model scoring can also be as great, or greater, than costs associated with training the model. In other words, models may be trained infrequently in an offline fashion in resource-rich or uniform cloud environments, but the same trained model may be scored many times and deployed in performance-critical, diverse environments.

Embodiments described herein address these issues by generating a neural network model from a traditional ML model. In an example system, a ML pipeline parser is configured to identify a set of ML operators for a previously trained ML pipeline (e.g., comprising a traditional ML model), and map the set of ML operators to a set of neural network operators. The ML pipeline parser generates a first neural network representation using the set of neural network operators. A neural network optimizer is configured to perform an optimization on the first neural network representation to generate a second neural network representation. A tensor set provider outputs a set of tensor operations based on the second neural network representation for execution on a neural network framework. In this manner, a traditional ML pipeline can be converted into a neural network pipeline that may be executed on an appropriate framework, such as one that utilizes specialized hardware accelerators.

This approach has numerous advantages, including but not limited to improving the performance of generating predictions during a scoring stage of a model. For instance, by converting a traditional ML pipeline to a NN representation, the NN representation may be executed on hardware accelerators that otherwise would be difficult to utilize for traditional ML models, resulting in improved overall performance when deployed (e.g., by leveraging parallel processing capabilities of such accelerators when executing the neural network framework, in contrast to traditional ML models where a tree, or collection of trees, is typically traversed). Because scoring may be carried out in quicker fashion due to leveraging parallel processing of the hardware accelerators, utilization of the hardware may be preserved, thereby resulting in lower overall costs during scoring and enabling scoring to be performed with increased frequency. Further, example embodiments described herein may allow for optimizations on the neural network representation that may otherwise be unavailable for traditional ML pipelines, which can further reduce processing resources of the computing device used during scoring.

Furthermore, existing ML solutions can lead to a large number of operator translations when supporting different ML frameworks over different deployment environments. For instance, existing solutions may lead to an O(N×M) number of translations to support N operators from various ML frameworks against M deployment environments. Techniques described herein may enable a reduction in this number by utilizing compilation and optimization techniques to translate a broad set of traditional ML operators into a smaller set of K core operators, thereby reducing the cost to O(N)+O(K×M). Further, because the set of K core operators can be reduced to tensor computations, and therefore be executed over a neural network framework (e.g., a deep neural network framework) that executes on a hardware accelerator or other specialized processor, improved resource efficiency and improved portability can also be achieved. For instance, features provided by DNN inference systems (e.g., ease of deployment, operator optimizations, and accelerator support) can be leveraged for the reduced number of operators. Further, since the number of core operators is reduced to a set of K core operators, the infrastructure complexity can be reduced to just O(N) operator translations. Still further, by reducing the number to a set of K core operators, an overall reduction in engineering effort can also be achieved, as efforts to optimize runtimes can focus on the reduced set of operators, rather than the larger set of traditional ML operators.

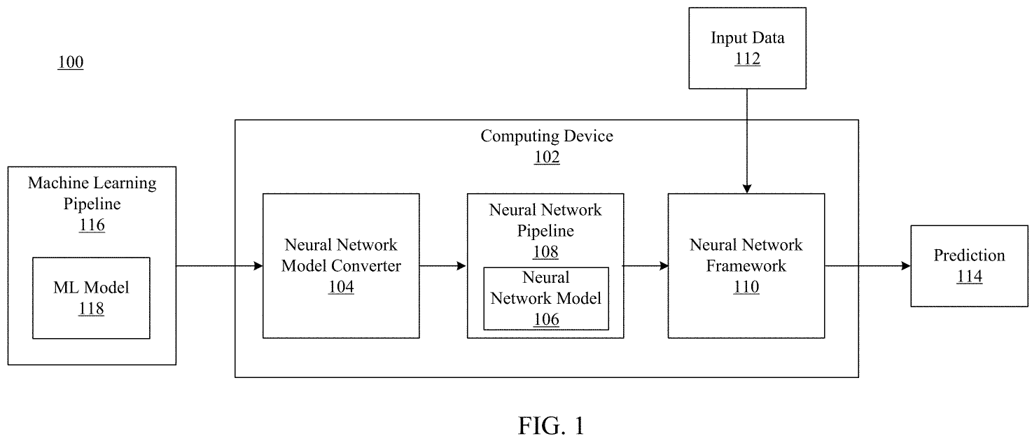

Example embodiments will now be described that are directed to techniques for generating a neural network model. For instance, FIG. 1 shows a block diagram of a system 100 comprising a computing device 102, input data 112, a prediction 114, and a ML pipeline 116. As illustrated in FIG. 1, computing device 102 includes a neural network model converter 104, neural network pipeline 108, and a neural network framework 110. Neural network pipeline 108 includes neural network model 106. Neural network framework 110 may obtain input data 112 and generate prediction 114 based on execution of neural network pipeline 108 that includes neural network model 106. As shown in FIG. 1, ML pipeline 116 includes ML model 118, which may comprise a traditional ML model that was previously trained. Each of these components will now be described in more detail.

Computing device 102 may include one or more devices (e.g., computing devices, servers, etc.) for applying a neural network model to generate a prediction (e.g., a predicted value, a predicted class, etc.). For instance, computing device 102 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device (e.g., a head-mounted device including smart glasses such as Google® Glass™, etc.), an Internet of Things (IoT) device, or other type of mobile device, or a stationary computing device such as a desktop computer or PC (personal computer), or a server. In some illustrative embodiments, computing device 102 may comprise a server or a collection of servers (e.g., cloud-based devices) for generating predictions based on application of a neural network model. In example embodiments, computing device 102 also comprises neural network model converter 104 configured to convert a traditional ML pipeline to a neural network representation, as will be described in greater detail below. It is noted, however, that neural network model converter 104 need not be implemented on the same computing device as neural network pipeline 108 and/or neural network framework 110. Rather, in some implementations, neural network model converter 104, neural network pipeline 108, and/or neural network framework 110 may be implemented on and/or distributed across a plurality of computing devices.

In some implementations, computing device 102 may comprise a central processing unit (CPU) and one or more additional processing units, such as a graphics processing unit (GPU), a field-programmable gate array (FPGA), an Application Specific Integrated Circuit (ASIC), or any other processor that may be configured to serve as a backend for neural network framework 110 for executing certain types of operations, including but not limited to tensor operations. As used herein, a tensor may comprise a generalization of vectors and/or matrices (e.g., a multidimensional array). Tensor operations may include any type of operation that may be performed on a tensor or a combination of tensors, including operations that may modify a structure of a tensor, mathematic operations that perform computations on values of a tensor, or any other type of operation involving one or more tensors.

Neural network model converter 104 is configured to convert ML pipeline 116 (which includes ML model 118, and any additional operators and/or models that may not be expressly illustrated as part of ML pipeline 116) into neural network pipeline 108 that includes neural network model 106. ML pipeline 116 may comprise a predictive pipeline, such as a set of Directed Acyclic Graphs (DAGs) of ML operators that include trained models, pre-processors, featurizers, missing-value imputers, etc. ML pipeline 116, including ML model 118, may be deployed once trained, and may be provided with new input data to generate a prediction, a process referred to as model scoring, inference, serving, pipeline evaluation, or prediction serving. ML pipeline 116 may be trained using a collection of learning data (e.g., historical data).

In examples, ML pipeline 116 may include, among other things, featurizers, which can be stateless imperative code (e.g., string tokenization) or data transformations fit to the data (e.g., min/max normalization) and models, commonly decision tree models (or ensembles) or linear models, fit to the data. Each featurizer may be defined by an algorithm (e.g., to compute the n-gram of an input string) that may convert raw data to feature vectors. Each trained model may be defined by a prediction function (e.g., transforming input features into a prediction score, such as 0 or 1 for a binary classification). In some implementations, ML pipeline 116 may contain up to tens of operators out of a set of multiple hundreds. Predictions using ML pipeline 116 typically require using the entire pipeline during an inference phase, as the entire pipeline was fit to the training data. In some examples, ML pipeline 116 may featurizers and model implementations may not be expressed in a shared logical abstraction, but rather in an ad-hoc fashion using programming languages such as R, Python (e.g., scikit-learn), Java (e.g., H2O), C++ or C # (e.g., ML.NET), or any other suitable programming language. Accordingly ML pipeline 116 may be configured to use many operators (and frameworks) across multiple target environments.

In some further implementations, ML pipeline 116 may include a mix of algebraic (e.g., linear algebra) and algorithmic operators organized in the form of a DAG. Algorithmic operators may comprise asymmetric control flow and data access patterns, such as decision tree models. Algebraic operators may comprise mathematical operators such as linear regression, among others. Tree models can include single tree, tree ensemble, including any one or more of a decision tree, random forest, LightGBM, XGBoost, etc., as appreciated by those skilled in the relevant arts. Trained ML pipeline 116 may include, for instance, a tree (or an ensemble thereof) that identifies a plurality of nodes and conditions that defines how the tree should be traversed during an inference or scoring stage. In other words, trained ML pipeline 116 may comprise a DAG that will be composed of a set of training parameters (e.g., weights, labels, and any other parameters based on training the ML pipeline), where the parameters may dictate how the pipeline should be evaluated when scoring.

Accordingly, ML pipeline 116 may comprise a set of operators that make up a DAG for generating a prediction based on input data. Examples of such ML operators include, but are not limited to, text feature extractors (e.g., CountVectorizer), feature pre-processing operators (e.g., SimpleImputer, Imputer, ColumnTransformer, RobustScaler, MaxAbsScaler, MinMaxScaler, StandardScaler, Binarizer, KBinsDiscretizer, Normalizer, PolynomialFeatures, OneHotEncoder, LabelEncoder, FeatureHasher), decomposition operators (e.g., Principal Component Analysis (PCA), Truncated Singular Value Decomposition (SVD)), feature selectors (e.g., SelectKBest), neural network operators (e.g., Multi-Layer Perceptron (MLP) Classifier), tree operators (e.g., DecisionTreeClassifier, RandomForestClassifier/Regressor, GradientBoostingClassifier/Regressor, XGBClassifier/Regressor, LGBMClassifier/Regressor), linear classifiers (e.g., LinearRegression, Logistic Regression, Linear Support Vector Machine (SVC), SVC, NuSVC, Stochastic Gradient Descent (SGD) Classifier, LogisticRegressionCV), or other operators (e.g., BernouliNB, MultinomialNB, KMeans).

As described above, neural network model converter may be configured to convert ML pipeline 116 into a neural network pipeline that may be executed in a different environment, such as a runtime environment executed using one or more hardware accelerators (e.g., GPUs). Examples of such runtime environments include, but are not limited to, environments in which scale-out batch or interactive serving is performed, personal computers, mobile devices, and IoT devices, etc. In some implementations, the runtime environment may be configured to execute tensor operations over such hardware accelerators. As will be described in greater detail below, neural network model converter 104 may identify ML operators for ML pipeline 116 that was previously trained, map the operators to a set of neural network operators, and generate a first neural network representation using the set of neural network operators. In some implementations, the set of neural network operators may comprise a total number of operators that is less than the set of ML operators, such that the total number of operators used upon conversion is reduced. Neural network model converter 104 may also be configured to perform one or more optimizations on the neural network representation and output a set of tensor operators based on an optimized neural network representation that may be executed on neural network framework 110.

When neural network pipeline 108 (comprising the tensor operators outputted by neural network model converter 104) is executed on neural network framework 110, input data 112 may be received, and based on such input data and execution of neural network pipeline 108, prediction 114 may be generated, such as a class prediction, a score, etc. Thus, in the disclosed manner, rather than evaluating input data 112 using machine learning pipeline 116, input data 112 may be evaluated using neural network pipeline 108 that is executed over specialized hardware (e.g., GPUs or other processing units that are configured to execute tensor operations with improved performance), resulting in overall performance improvements when generating prediction 114.

It is noted and understood that implementations are not limited to the illustrative arrangement shown in FIG. 1. Rather, system 100 comprise any number of computing devices and/or servers coupled in any manner. For instance, though computing device 102 and ML pipeline 116 are illustrated as separate from each other, any one or more of such components (or subcomponents) may be co-located, located remote from each other, may be implemented on a single computing device or server, or may be implemented on or distributed across one or more additional computing devices not expressly illustrated in FIG. 1. Further, any of such components may be coupled via one or more networks such as local area networks (LANs), wide area networks (WANs), enterprise networks, the Internet, etc., and may include one or more of wired and/or wireless portions. Such components may communicate with each other via one or more of the networks through a respective network interface. In an embodiment, computing device 102 and ML pipeline 116 (or subcomponents thereof) may communicate via one or more application programming interfaces (API).

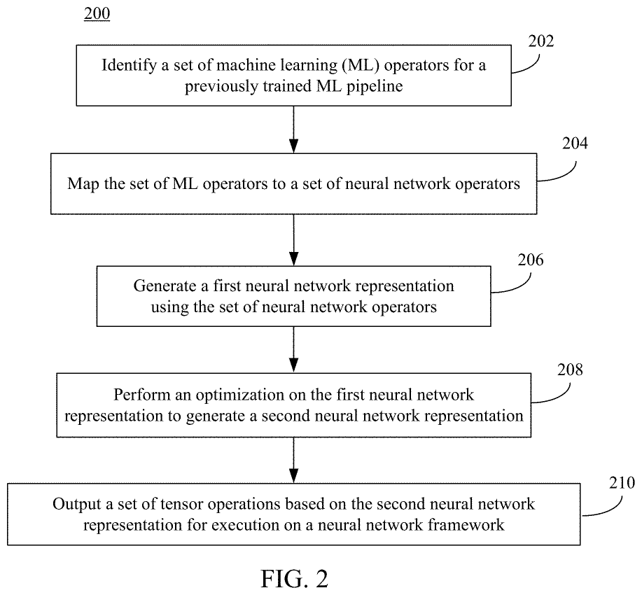

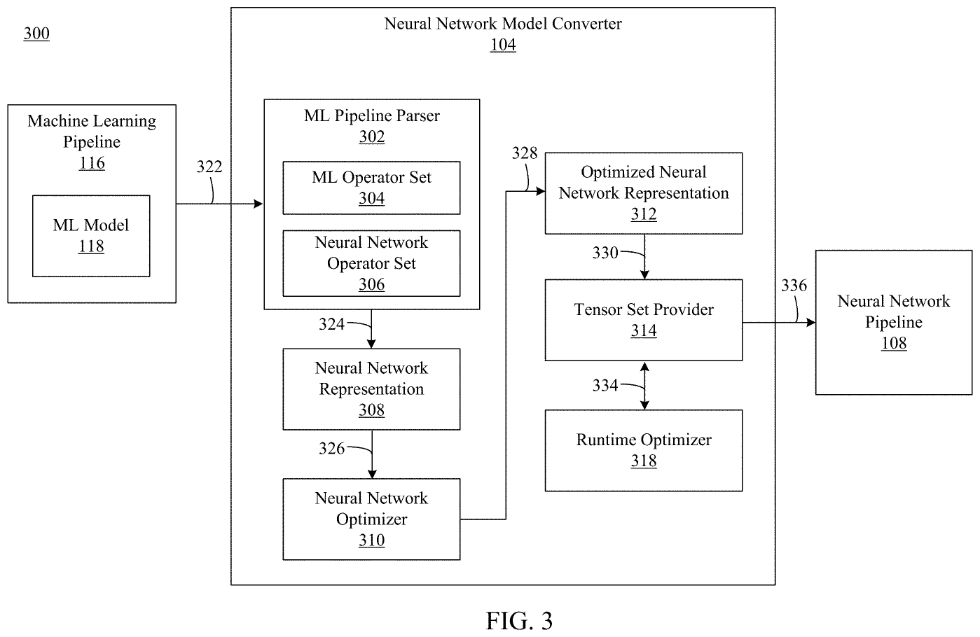

Neural network model converter 104 may operate in various ways to convert ML pipeline 116 to neural network representation. For instance, neural network model converter 104 may operate according to FIG. 2. FIG. 2 shows a flowchart 200 of a method for generating a neural network model, in accordance with an example embodiment. For illustrative purposes, flowchart 200 and neural network model converter 104 are described as follows with respect to FIG. 3.

FIG. 3 shows a block diagram of an example system for converting a ML model to a neural network model, in accordance with an example embodiment. As shown in FIG. 3, system 300 includes an example implementation of neural network model converter 104, an example implementation of neural network pipeline 108, and an example implementation of machine learning pipeline 116. Neural network model converter 104 includes a ML pipeline parser 302, a neural network representation 308, a neural network optimizer 310, an optimized neural network representation 312, a tensor set provider 314, and a runtime optimizer 318. As shown in FIG. 3, ML pipeline parser 302 includes a ML operator set 304 and a neural network operator set 306. ML pipeline parser 116 includes an example implementation of ML model 118.

Flowchart 200 begins with step 202. In step 202, a set of ML operators are identified for a previously trained ML pipeline. For instance, with reference to FIG. 3, ML pipeline parser 302 is configured to obtain 322 ML pipeline 116 and identify ML operator set 304 for ML pipeline 116. ML operator set 304 may include each of the operators used to train ML pipeline 116, including but not limited to algebraic and/or algorithmic operators, non-limiting examples of which have been described herein. For example, ML operator set 304 may comprise a listing of operators for ML pipeline 116, such as decision tree operators, gradient boost operators, featurizers, etc. In some implementations, ML operator set 304 may define a DAG of operators that represents ML pipeline 116.

In some example embodiments, ML pipeline parser 302 is configured to define a list of supported operators (e.g., operators supported for conversion by neural network model converter 104). In such embodiments, for each of the supported operators, operators utilized in ML pipeline 116 may be registered. For instance, if a gradient boosted tree operator is included a listing of supported operators, each operator of ML pipeline utilizing a gradient boosted tree algorithm may be registered as belonging to the supported gradient boosted tree operator. Such registration may be repeated for each supported operator and each operator present in ML pipeline 116 to generate ML operator set 304.

In step 204, the set of ML operators is mapped to a set of neural network operators. For instance, with reference to FIG. 3, ML pipeline parser 302 is configured to map ML operator set 304 to neural network operator set 306. In examples, neural network operator set 306 may comprise a set of tensor-based implementations that may implement one or more ML-based operators. Once each of the tensor-based implementations is registered, ML pipeline parser 302 may implement a conversion for mapping each of the ML operators to one or more of the neural network operators. For instance, a particular ML operator in ML operator set 304 may be mapped to a particular tensor-based implementation in neural network operator set 306. In this manner, each of the operators in ML operator set 304 may be mapped (e.g., converted to) a tensor-based operator of neural network operator set 306. It is noted and understood that for each operator, ML pipeline parser 302 may select a particular tensor-based implementation (e.g., the best or most suitable one for a given implementation) from among a plurality of implementations. For instance, ML pipeline parser 302 may be configured to map a particular ML operator to one of a plurality of tensor implementations, based on the information contained in the ML operator. In examples, neural network operator set 306 may be registered via one or more APIs of a neural network framework (e.g., DNN framework).

As noted herein, neural network operator set 306 may include tensor-based operators of various ML operators. Examples of operators in neural network operator set 306 include, but are not limited to, Generic Matrix Multiplication (GEMM), elementwise add/sub/multiplication, elementwise logical operators (e.g., and, or), elementwise bitwise operators (e.g., xor, &, |, <<, >>), tensor slice, index select, gather, tensor concatenation, flatten, reshape, casting, squeeze, unsqueeze, absolute, power operators, exponential operators, argmax operators, max operators, reducesum operators, rectified linear unit (ReLU) operators, sigmoid operators, hyperbolic tangent functions, softmax operators, LogSumExp operators, is nan operators, where operators (e.g., torch.where(cond, A, B), where a tensor of elements selected from A or B is returned based on the condition), or any other tensor-based operators.

In example embodiments, a total number of operators in neural network operator set 306 may be less than a total number of operators in ML operator set 304. For instance, ML operator set 304 may comprise N operators (which may be in the hundreds) across various ML frameworks against M deployment environments. However, neural network operator set may comprise a total of K core operators that is less than N operators of ML operator set 304. As a result of reducing the number of operators to a smaller set of K operators, engineering effort for implementing and maintaining such operators may also be reduced.

In step 206, a first neural network representation is generated using the set of neural network operators. For instance, with reference to FIG. 3, ML pipeline parser 302 is configured to generate 324 neural network representation 308 using neural network operator set 306. Neural network representation 308 may comprise a representation of tensor-based operators that may be used for execution in a suitable neural network runtime, such as a runtime executing using specialized hardware as described herein. In some implementations, neural network representation 308 may comprise an in-memory intermediate representation in which each operator of ML operator set 304 is encoded, along with any additional information (e.g., input/output dependencies, etc.), such that the intermediate representation may be optionally optimized, as described below.

Thus, as described above, where ML pipeline 116 comprises a graph of operators (e.g., a DAG of operators), ML pipeline parser 302 may be configured to convert or map each of the operators into one or more suitable tensor implementations, thereby generating a tensor representation (neural network representation 308) that is composed of tensor-based operators for the same graph of ML operators.

In example embodiments, ML pipeline parser 302 is configured to generate neural network representation 308 without performing a backpropagation of parameters. For instance, ML pipeline parser 302 may populate nodes of a neural network based on the structure and/or parameters of ML pipeline 116 through one or more compilation techniques, as described below (e.g., in Section III.D). Using such techniques, which may convert a tree model into a plurality of tensors, neural network representation 308 may be generated without training (e.g., without backpropagation of weights through the network). Rather, ML pipeline parser 302 may generate neural network representation 308 using a step function, resulting in a neural network pipeline that may perform the same predictions as ML pipeline 116, but with improved performance.

In step 208, an optimization is performed on the first neural network representation to generate a second neural network representation. For instance, with reference to FIG. 3, neural network optimizer 310 may be configured obtain 326 neural network representation 308 and perform an optimization thereon to generate 328 optimized neural network representation 312. Optimizations performed by neural network optimizer 310 may include, but are not limited to, graph transformations (e.g., feature selection push-down), cross-operator optimizations (e.g., fusing, operator batching, etc.), cost-based optimizations (e.g., batching multiple trees, reducing or minimizing kernel invocations, optimizations based on a target backend, selecting a particular operator candidate from among a plurality of candidates, reducing overhead, such as by injecting a feature selector to select a majority of the features, selecting where to place an operator, such as by selecting a CPU for a small batch or a GPU for a large batch), or any other suitable optimizations. Furthermore, if a plurality of potential compilation strategies are present for a given ML operator, neural network optimizer 310 may be configured to annotate neural network representation 308 with an indication of the compilation strategy to be used for the operator given the input parameters.

In this manner, neural network optimizer 310 may perform one or more optimizations (e.g., optimization passes) over neural network representation 308 to generate a potentially modified, or optimized, neural network representation. It is noted and understood that neural network optimizer 310 need not generate a second neural network representation that is different from neural network representation 308 in all instances. For example, if neural network optimizer 310 performs one or more optimizations but the optimizations did not result in improved performance, neural network optimizer 310 may output the same neural network representation (i.e., neural network representation 308) that was inputted. It is also noted and understood that neural network optimizer 310 need not perform an optimization on neural network representation 308 in all example embodiments. Rather, in some example embodiments, neural network representation 308 may comprise a set of tensor operations without performing optimization.

In step 210, a set of tensor operations based on the second neural network representation is outputted for execution on a neural network framework. For instance, with reference to FIG. 3, tensor set provider 314 is configured to obtain 330 optimized neural representation 312 and output 336 a tensor operator set based thereon as neural network pipeline 108 for execution on neural network framework 110. In other words, a set of tensor operators based on optimized neural network representation 312, which may comprise a tensor-based DAG of operators, may be outputted and executed on neural network framework 110. As described herein, neural network framework 110 may comprise any combination of a CPU and one or more specialized processors or hardware accelerators (e.g., a GPU, Intelligent Processing Unit (IPU), Tensor Processing Unit (TPU), FPGA, ASIC, etc.) that may provide improved performance when executing tensor operations.

In some implementations, tensor set provider 314 may be configured to output a set of tensor operations based on a target runtime environment. For instance, tensor set provider 314 may be configured to output different sets of tensor operators based on the type of hardware accelerators(s) of the target runtime (e.g., by outputting a first set of tensor operators that may be executed on a first type of hardware accelerator, outputting a second set of tensor operators based on a second type of hardware accelerator that is different than the first hardware accelerator, etc.). In this manner, neural network model converter 104 may be configured to support conversions of ML pipeline 116 for various different target runtime formats.

Upon outputting a tensor operator set as neural network pipeline 108, neural network pipeline 108 may then be executed over neural network framework 110, such as during an inference or scoring stage. For instance, when input data 112 is received by neural network framework 110, neural network framework 110 may apply the input data to neural network pipeline 108 and generate prediction 114 (e.g., a predicted classification, a predicted value, etc.) using specialized hardware. In this manner, by compiling ML pipeline 116 into a format comprising a set of tensor-based operations that can be executed in a specialized runtime environment, processing capabilities of the specialized runtime environment can be leveraged that may not have been available for ML pipeline 116, resulting in improved performance during an inference or scoring stage.

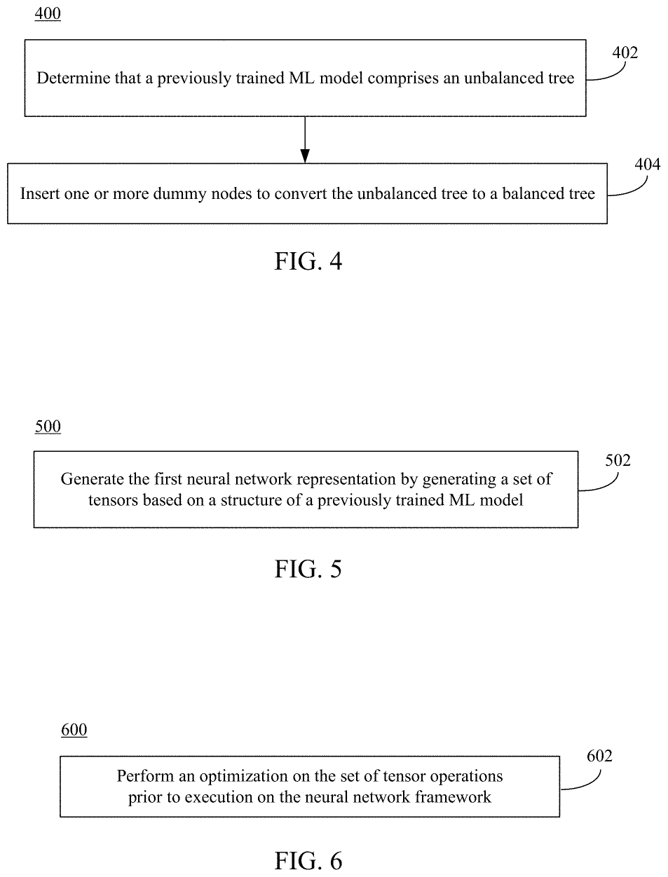

In some example implementations, ML pipeline parser 302 may be configured to modify a tree structure of ML pipeline 116. For example, FIG. 4 shows a flowchart of a method for balancing a tree of a previously trained ML model, in accordance with an example embodiment. In an implementation, the method of flowchart 400 may be implemented by ML pipeline parser 302. FIG. 4 is described with continued reference to FIG. 3. Other structural and operational implementations will be apparent to persons skilled in the relevant art(s) based on the following discussion regarding flowchart 400 and system 300 of FIG. 3.

Flowchart 400 begins with step 402. In step 402, it is determined that a previously trained ML model comprises an unbalanced tree. For instance, with reference to FIG. 3, ML pipeline parser 302 may determine that previously trained ML model 118 comprises an unbalanced tree. An unbalanced tree may include, for example, a graph or tree that is not a perfect binary tree. Such an unbalanced tree may include, for instance, a tree in which any internal node does not have exactly two children, or in which all leaf nodes are not at the same depth level. Further examples regarding the determination of a model comprising an unbalanced tree are described below.

In step 404, one or more dummy nodes are inserted to convert the unbalanced tree to a balanced tree. For instance, with reference to FIG. 3, ML pipeline parser 302 may be configured to insert one or more dummy nodes in an unbalanced tree of ML model 118 to convert the unbalanced tree to a balanced tree. In other words, ML pipeline parser 302 may convert the unbalanced tree into a tree in all internal nodes have two children and all leaf nodes are at the same depth level. ML pipeline parser 302 may insert one or more dummy nodes in various ways.

For example, ML pipeline parser 302 may incorporate computational and storage redundancy to make a tree (or all trees in an ensemble of trees) have the same number of nodes. To achieve this, ML pipeline parser 302 may first determine the maximum depth of the tree (e.g., a decision tree). Upon determining the maximum depth of a tree, the tree is transformed by including one or more dummy internal nodes as appropriate, and replicating the corresponding leaf nodes to make the tree a balanced tree. For instance, if an unbalanced binary tree has a tree depth of D, and Lₖ is a leaf node which is at a depth of Dₖ<D, Lₖ may be pushed to a depth D by replacing Lₖ with a perfect sub-tree of depth D−Dₖ, and map all the leaf nodes of the sub-tree to the label of the original leaf node. In this manner, the decision nodes in the introduced sub-tree may perform arbitrary comparisons, as the outcome is the same along any path. In this manner, by pushing all leaf nodes at depth<D to a depth of D, ML pipeline parser 302 may transform the original tree to a perfect or balanced tree with the same functionality. Additional details and benefits regarding the conversion of an unbalanced tree to a balanced tree are described in greater detail below.

As described above, ML pipeline parser 302 may be configured to generate neural network representation 304 using a set of neural network operators. For example, FIG. 5 shows a flowchart of a method for generating a set of tensors based on a structure of a ML model, in accordance with an example embodiment. In an implementation, the method of flowchart 500 may be implemented by ML pipeline parser 302. FIG. 5 is described with continued reference to FIG. 3. Other structural and operational implementations will be apparent to persons skilled in the relevant art(s) based on the following discussion regarding flowchart 500 and system 300 of FIG. 3.

Flowchart 500 begins with step 502. In step 502, a first neural network representation is generated by generating a set of tensors based on a structure of a previously trained ML model. For instance, with reference to FIG. 3, ML pipeline parser 302 may generate neural network representation 302 by generating a set of tensors based on a structure of a previously trained ML model 118. As used herein, a tensor is a generalization of vectors and matrices (multidimensional array). For instance, based on a tree structure of ML model 118 that was previously trained, ML pipeline parser 302 may select a particular technique from among a plurality of techniques for generating a set of tensors. In implementations, ML pipeline parser 302 may generate tensors using a variety of techniques, including evaluation of a tree as a series of GEneric Matrix Multiplication (GEMM) operations, mimicking tree traversal using tensor operations, and mimicking tree traversal of a perfect binary tree. Each of these techniques, as will be described in greater detail below, may generate a set of tensors that are based on a structure of ML model 118. For instance, ML pipeline parser 302 may be configured to generate a set of tensors that capture the structure of a tree. In this manner, the set of tensors may be used to emulate the previously trained ML model, which may be evaluated during a scoring phase using tensor operations executed on specialized hardware. Additional details regarding these techniques, and selection thereof in particular situations, are described in greater detail below.

In some example implementations, runtime optimizations may be performed prior to execution of a neural network model on a neural network framework. For example, FIG. 6 shows a flowchart of a method for performing an optimization on a set of tensor operations, in accordance with an example embodiment. In an implementation, the method of flowchart 600 may be implemented by runtime optimizer 318. FIG. 6 is described with continued reference to FIG. 3. Other structural and operational implementations will be apparent to persons skilled in the relevant art(s) based on the following discussion regarding flowchart 600 and system 300 of FIG. 3.

Flowchart 600 begins with step 602. In step 602, an optimization is performed on the set of tensor operations prior to execution on the neural network framework. For instance, with reference to FIG. 3, runtime optimizer 318 may obtain 334 tensor operators (e.g., a set of operators included in optimized neural network representation 312) and perform one or more optimizations thereon prior to execution of the tensor operator set on neural network framework 110. For example, optimized neural network representation 312 being generated based on a particular target runtime format, runtime-specific optimizations may be performed on optimized neural network representation 312 corresponding to the particular target runtime (e.g., the target DNN runtime), and a set of tensor operators may be outputted as a model used for prediction upon execution in the neural network framework. In other words, runtime optimizer 318 may perform one or more optimizations on optimized neural network representation 312 that may be specific to the target environment, such as optimizations that are specific to a particular type of processor (e.g., CPU, GPU, or other specialized hardware accelerator). Examples of such runtime optimizations include optimizations such as low-precision inference (e.g., in used in TensorRT™ provided by NVIDIA), optimized kernel generation (e.g., Tensor Virtual Machine (TVM), and any other runtime-specific optimizations as will be appreciated by those skilled in the relevant arts. Thus, while such optimizations may be unavailable for ML pipeline 116, techniques described herein may leverage such optimizations when generating neural network pipeline 108 for execution on neural network framework 110, which may lead to further performance improvements during a scoring or inference phase.

### III. Additional Neural Network Model Converting Embodiments

### A. Introduction

The following sections are intended to describe additional example embodiments in which implementations described herein may be provided. Furthermore, the sections that follow explain additional context for such example embodiments, details relating to the implementations, and evaluations of such implementations. The sections that follow are intended to illustrate various aspects and/or benefits that may be achieved based on techniques described herein, and are not intended to be limiting. Accordingly, while additional example embodiments are described, it is understood that the features and evaluation results described below are not required in all implementations.

In example neural network model converting embodiments, techniques may be implemented by one or more of computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, and/or runtime optimizer 318 (including any subcomponents thereof). Other structural and operational implementations will be apparent to persons skilled in the relevant art(s) based on the following discussion.

It is desired that ML in the enterprise utilize simpler and more efficient software infrastructure. As noted earlier, model scoring, the process of obtaining prediction from a trained model over new data, is a contributor to infrastructure complexity and cost, as models are typically trained once but used many times.

Recent advances in Deep Neural Networks (DNNs) and the subsequent expansion of DNN frameworks have fostered the creation of a new class of systems (e.g., ONNX, TVM, and TensorRT), in which a goal is to provide a runtime for DNN model inference with improved performance, ease of deployment on hardware accelerators (e.g., GPUs), and portability across platforms and devices. However, typical enterprise space data is tabular or structured, and classical Machine Learning (ML) techniques such as tree methods are frequently used, often within complex pipelines composed of data featurizers and feature selection operators. In this classical ML space, unified inference serving system do not exist. As a result, developers use solutions that may have subpar performance. As described, techniques described herein (e.g., neural network model converter 104) may be configured to compile classical ML pipelines into end-to-end into tensor computations. Such techniques may seamlessly leverage the features provided by DNN inference systems, e.g., ease of deployment, operator optimizations and GPU support. In this manner, neural network model converter 104 may enable the execution of classical ML pipelines on DNN prediction serving runtimes, which can enable a significant reduction in engineering effort, leverage optimizations in DNN prediction serving systems, enable execution on hardware accelerators, and improve the ease of deployment on devices (e.g., IoT) and platforms (e.g., web browser).

Operators in classical ML pipelines are typically a mix of both linear algebra (arithmetic) operators (e.g., generalized linear models, feature scaling) and algorithmic operators (e.g., random forest, gradient boosting trees, feature hashing). Techniques described herein may be used to compile algorithmic operators into tensor computations. In addition, with respect to prediction serving, low latency and efficient inference performance are desired, and therefore techniques enable compiled pipelines to have improved performance. Further, techniques described herein provide for system generality with support for many classical operators, while at the same time maintaining the ability to compile the source pipelines into many target environments including CPU, GPU, and other hardware accelerators.

As described herein, network model converter 104 may utilize an array of novel optimizations for classical ML pipelines, including but not limited to cost-based operator compilation strategy selections, DAG transformations, and cross-operator optimizations. Neural network model converter 104, which relates to techniques for improvements to model scoring, compiles featurization operators and traditional ML models (e.g., decision trees) into a smaller set of tensor operations. As a result, neural network model converter 104 may reduce infrastructure complexity and leverage neural network compilers and runtimes to generate efficient computations for both CPU and hardware accelerators.

The Underlying Challenge. Existing ML solutions lead to an O(N×M) explosion to support N operators from various ML frameworks against M deployment environments. It is expected that M is also destined to grow as ML is applied more and more widely across a broad range of enterprise applications and hardware. A brute-force approach tackling all combinations directly would dilute engineering focus leading to costly and less optimized solutions. Techniques described herein address this challenge.

Overview of Example Solution. Neural network model converter 104 may utilize compiler and/or optimizer techniques to translate a broad set of traditional ML operators into a smaller set of K core operators, reducing the cost to O(N)+O(K×M). In accordance with techniques described herein, neural network model converter 104 may reduce this set of core operators to tensor computations and therefore enable execution over DNN frameworks. These techniques enable DNN compilers, runtimes, and/or specialized hardware to be utilized to cover executing K operators across M different environments described above, which may reduce the infrastructure complexity to support traditional ML to just O(N) operator translations. Additionally, this cost can be absorbed by each of the input frameworks, as central coordination or standardization is not necessary. This translates to reduced infrastructure complexity, improved resource efficiency, and improved portability.

As described below, neural network model converter 104 may be configured to (1) translate traditional ML operators (both linear algebra-based such as linear models, and algorithmic ones such as decision trees) into tensor computations, (2) enable improvements when performing the computations in tensor space, and (3) reduce software complexity and improving model portability.

### B. ML and DNNs

An overview is provided below with respect to ML techniques and DNNs. Following the overview, it is explained how traditional ML operators and predictive pipelines may be compiled into tensor computations.

ML Predictive pipelines. The result of the data science workflow over traditional ML are predictive pipelines, i.e., Directed Acyclic Graphs (DAGs) of operators such as trained models, pre-processors, featurizers, missing-value imputers. The process of presenting a trained predictive pipeline with new data to obtain a prediction may be referred to in literature interchangeably as model scoring/inference/serving, pipeline evaluation, or prediction serving.

Packaging a trained pipeline into a single artifact is common practice. These artifacts may then be embedded inside host applications, or containerized and deployed in the cloud to perform model scoring. Python-based (e.g., scikit-learn), .NET-based (e.g., ML.NET), and Java-based (e.g., H₂O) are example toolkits that may be used to train and generate pipelines. However, such solutions are typically optimized for training, not for scoring. Scoring predictive pipelines may be challenging, as their operators are implemented in imperative code, and do not follow a shared logical or physical abstraction. Accordingly, supporting every operator in all target environments requires great effort, which is why existing frameworks described above typically have limited portability.

DNNs. Deep Neural Networks (DNNs) comprise a family of ML models that are based on artificial neurons. DNNs take raw features as input and perform a series of transformation operations. Unlike traditional ML where the ML transformations are complex and diverse, transformations in DNNs are drawn from a small set of simple tensor transformations (e.g., generic matrix multiplication, element-wise operations, etc.). Hence, a DNN can be represented using a DAG of tensor operators.

Runtimes for DNN Model Scoring. Various types of systems (e.g., runtime backends) may be used for DNN model scoring or inference. Such systems leverage the relative computational simplicity of neural networks by, among other things, accepting a DAG of tensor operations as input, which are executed by implementing a small set of highly optimized operator kernels on hardware. Focusing on just the scoring enables such systems to also perform additional inference-specific optimizations, which are not applicable for training.

Compiling Pipelines. Pipelines are generally composed of operators (with predictive functions) of two classes: algebraic (e.g., scalers or linear models), and algorithmic (e.g., one-hot encoder and tree-based models). Algorithmic operators perform arbitrary data accesses and control flow decisions. For example, in a decision tree ensemble potentially each tree is different from each other, not only with respect to the structure but also the decision variables and the threshold values. Conversely, tensor operators (such as matrix multiplication, element-wise operations) perform single instruction, multiple data (SIMD) bulk operations over the entire set of input elements.

As described herein, neural network model converter 104 may combine the strength of traditional ML pipelines on structured data with the computational and operational simplicity of DNN runtimes for model scoring. Once a model is trained (e.g., using traditional ML techniques), it can be represented as a prediction function transforming input features into a prediction score (e.g., 0 or 1 for binary classification), regardless of the training algorithm used. Similar observations may apply to featurizers fit to the data. Based on this, neural network model converter 104 may compile the prediction functions (as opposed to the training logic) for each operator in a pipeline into tensor computations and stitch them appropriately.

### C. Example System Overview

This section provides a high-level overview of neural network model converting embodiments, along with example implementation details.

### 1. High-Level Approach

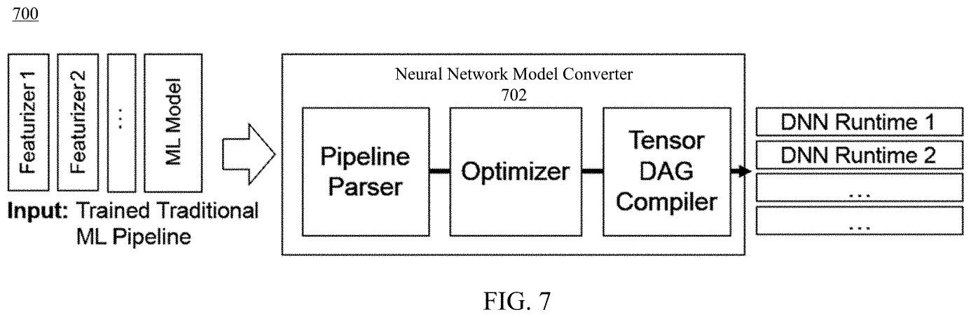

FIG. 7 shows a block diagram of a system 700 for converting a ML model to a neural network model, in accordance with an example embodiment. In examples, neural network model converter 702 may be an example implementation of neural network model converter 104. Neural network model converter 702 may take in a pre-trained classical ML pipeline as input and compiles it into a DAG of tensor computations. Unlike DNN-based models, which are expressed using low-level tensor operators, classical ML methods are typically expressed using a mix of high-level arithmetic and algorithmic operators. Feature scaling, one-hot encoding, and random forest evaluation are examples of some of those operators. During the compilation process, neural network model converter 104 may translates the obtained pipeline into an intermediate representation (IR) format. Before emitting the compiled tensor DAG, neural network model converter 104 invokes an optimizer to perform optimization passes over the IR. Additional details regarding the operation of system 700 will be described below.

Neural network model converter 702 may cast algorithmic operators into tensor computations by introducing a degree of redundancy, which includes both computational redundancy and storage redundancy. With computational redundancy, computations are performed for more than what may be needed for execution, and with storage redundancy, data structures may be used to store more than what may be needed. These redundancies enable us neural network model converter 702 to transform the arbitrary data accesses and control flow of the original algorithmic operators (e.g., decision trees) into bulk operations that may be compiled into tensor computations which may be executed on hardware accelerators.

Based on the level of redundancy introduced, different compilation strategies may be implemented. Therefore, different tensor implementations may exist for a given traditional ML operator. The compilation strategies are discussed below for representative operators. The tensor implementation to be used in scenarios may be informed by model characteristics (e.g., tree-structure for tree-based models, or sparsity for linear models) and runtime statistics (e.g., batch size of the inputs). In addition, heuristics at the operator level, runtime-independent optimizations at the pipeline level, and runtime-specific optimizations at the execution level enable neural network model converter 702 to further improve predictive pipelines performance end-to-end. These techniques may enable neural network model converter 702 to both (1) apply optimizations that may be typically implemented for traditional ML, and not captured by DNN runtimes; and (2) leverage DNN runtime optimizations once the traditional ML is compiled into tensor computations. Finally, by compiling traditional predictive pipelines into tensor computations, neural network model converter 702 may enable end-to-end pipelines to be executed on each of the hardware platforms supported by the target tensor runtimes.

Compiling Algorithmic Operators into Tensor Computations. As described herein, neural network model converter 702 may to translate algorithmic operators into tensor computations. Algorithmic operators perform inherently asymmetric data accesses and control flow decisions. For example, in a decision tree ensemble, potentially each tree is different from each other with respect to the structure, the decision variables, and the threshold values. Tensor operators, such as matrix multiplication, index select, tensor concatenation, and elementwise logical operators, however, perform symmetric (bulk) operations (e.g., symmetric control flow and data accesses) that can improve overall performance. To cast algorithmic operators into tensor computations, a degree of redundancy is introduced as explained above. Based on the level of redundancy introduced, different compilation strategies may be used. The degree of redundancy is informed by model statistics such a tree-structure (for tree-based models) or sparsity (e.g., for linear models). In the case of decision tree ensembles, several strategies are described herein.

### 2. Example System Architecture and Implementation

As explained earlier, FIG. 7 provides a high-level architecture of a system 700 for compiling a traditional ML pipeline to tensor computations. As shown in FIG. 7, neural network model converter 702 includes a (1) Pipeline Parser, (2) Optimizer, and (3) Tensor DAG Compiler. The Pipeline Parser shown in FIG. 7 may be an example implementation of ML pipeline parser 302, the Optimizer shown in FIG. 7 may be an example implementation of neural network optimizer 310, and the Tensor DAG Compiler may be an example implementation of tensor set provider 314.

Given a predictive pipeline and a set of input parameters (i.e., batch size, input type, target DNN runtime, target hardware device), the Pipeline Parser of neural network model converter 702 may an in-memory Intermediate Representation (IR) object encoding each operator in the pipeline and related input/output dependencies. The Optimizer of neural network model converter 702 may then run optimization passes over the IR to produce a potentially modified IR. Furthermore, if there is more than one potential compilation strategy for an operator, the Optimizer of neural network model converter 702 may annotate the IR with the compilation strategy to be used for that specific operator given the input parameters. Afterwards, the Tensor DAG Compiler of neural network model converter 702 may select the optimized IR object and compile it into tensor operations following the target DNN runtime format. Runtime-specific optimizations may then be triggered at this level. Finally, the model may be exported in the native format of the target runtime for model prediction.

Example ML models that may be used in accordance with techniques described herein include, but are not limited to: LogisticRegression, SVC, NuSVC, LinearSVC, SGDClassifier, LogisticRegressionCV, DecisionTreeClassifier/Regression, RandomForestClassifier/Regression, ExtraTreesClassifier, GradientBoostingClassifier/Regression, XGBClassifier/Regression, LGBMClassifier/Regression, HistGradientBoostingClassifier, MLPClassifier, BernoulliNB, GaussianNB, and MultinomialNB. Example featurizers that may be used in accordance with techniques described herein include, but are not limited to: SelectKBest, VarianceThreshold, SelectPercentile, PCA, KernelPCA, TruncatedSVD, FastICA, SimpleImputer, Imputer, MissingIndicator, ColumnTransformer, RobustScaler, MaxAbsScaler, MinMaxScaler, StandardScaler, Binarizer, KBinsDiscretizer, Normalizer, PolynomialFeatures, OneHotEncoder, LabelEncoder, and FeatureHasher. Example tensor operators that may be used in accordance with techniques described herein include, but are not limited to: matmul, add, mul, div, lt, le, eq, gt, ge, &, |, <<, >>, bitwise xor, gather, index_select, cat, reshape, cast, abs, pow, exp, arxmax, max, sum, relu, tanh, sigmoid, logsumexp, isnan, and where. These examples are provided for illustrative purposes only, and are not intended to be limiting.

### D. Compilation

As described herein, neural network model converter 702 may be used to compile many representative algorithmic operators into tensor computations. For illustrative purposes, example implementations will be described relating to tree-based models, although such examples are not intended to limit the scope of the disclosed embodiments. Additional techniques are also described below that may be used for both algorithmic and arithmetic operators.

### 1. Compiling Tree-Based Models

Neural network model converter 702 may be configured to implement various strategies for compiling tree-based models for classification tasks (e.g., based on runtime statistics such as batch size and tree structure). Strategies may differ based on the degree of redundancy introduced. Selection of the appropriate strategy in circumstances will be described below. For the sake of discussion, it is assumed that decision nodes perform<comparisons.

Strategy 1: GEMM. In one implementation, neural network model converter 702 may cast the evaluation of a tree as a series of three GEneric Matrix Multiplication (GEMM) operations interleaved by two element-wise logical operations. Table 1 below describes the notations used for Strategy 1 (GEMM).

TABLE 1
Notations used for Strategy 1

| Symbol | Description |
|---|---|
| N, I, L, F, C | Ordered lists with all nodes, internal nodes, leaf |
| | nodes, features, and classes, respectively |
| X ∈ [symbol] ^{n×\|F\|} | Input records (n is the number of records). |
| A ∈ [symbol] ^{\|F\|×\|I\|} | ${A}_{i j} = \{ \begin{matrix}1 , & {I}_{i} evaluates {F}_{i} \\ 0 , & Otherwise\end{matrix}$ |
| B ∈ [symbol] ^{\|I\|} | Bᵢ = ThresholdValue(Iᵢ) |
| C ∈ [symbol] ^{\|I\|×\|L\|} | ${C}_{i , j} = \{ \begin{matrix}- 1 , & ∈ RightSubTree ( {I}_{i} ) \\ 1 , & {L}_{j} ∈ LeftSubTree ( {I}_{i} ) \\ 0 , & Otherwise\end{matrix}$ |
| D ∈ [symbol] ^{\|L\|} | ${D}_{k} = \sum 1 ( k == LeftChild ( Parent ( k ) ) )$ $k ∈ L {\to }^{path} Root$ |
| E ∈ [symbol] ^{\|L\|×\|C\|} | ${E}_{i , j} = \{ \begin{matrix}1 , & {L}_{i} {⟶}^{map to} {C}_{j} \\ 0 , & Otherwise\end{matrix}$ |

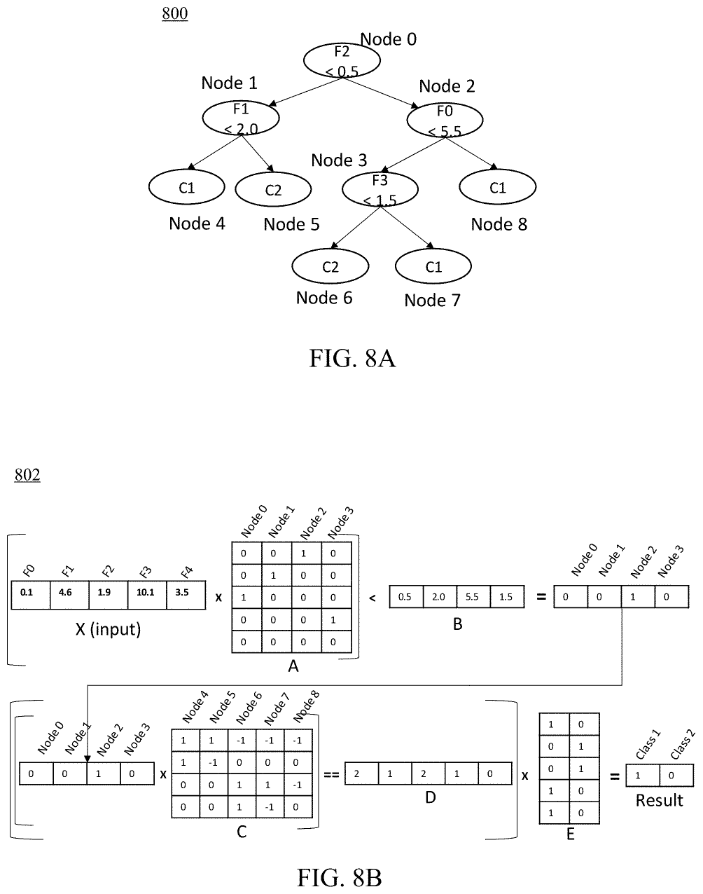

Given a tree, five tensors may be created which collectively capture the tree structure: A, B, C, D, and E. A graphical representation of an execution of the GEMM strategy is depicted in FIGS. 8A-8B, which show an illustrative conversion of a tree-based ML model, in accordance with an example embodiment. For instance, FIG. 8A depicts a tree structure 800 of an illustrative ML model. FIG. 8B shows a collection 802 of tensors (A, B, C, D, and E) that may be created to capture the tree structure 802. A captures the relationship between input features and internal nodes. B is set to the threshold value of each internal node. For any leaf node and internal node pair, C captures whether the internal node is a parent of that internal node, and if so, whether it is in the left or right sub-tree. D captures the count of the internal nodes in the path from a leaf node to the tree root, for which the internal node is the left child of its parent. Finally, E captures the mapping between leaf nodes and the class labels. Given these tensors, Algorithm 1, below, presents how tree scoring may be performed for a batch of input records X:

Algorithm 1: GEMM Strategy
Input: X ∈ [symbol] ^{n × |F|}, Input records
Output: R ∈ {0, 1}^{n × |C|}, Predicted class labels

| | |
|---|---|
| /* Evaluate all internal nodes | */ |
| T ← GEMM(X, A) | // T ∈ [symbol] ^{n × \|I\|} |
| T ← T < B | // T ∈ [symbol] ^{n × \|I\|} |
| /* Find the leaf node which gets selected | */ |
| T ← GEMM(T, C) | // T ∈ [symbol] ^{n × \|L\|} |
| T ← T == D | // T ∈ [symbol] ^{n × \|L\|} |
| /* Map selected leaf node to class label | */ |
| R ← GEMM(T, E) | // R ∈ [symbol] ^{n × \|C\|} |

The first GEMM may be used to match each input features with the internal node(s) using it. The following <operations are used to evaluate all the internal decision nodes and produces a tensor of 0s and 1s based on the false/true outcome of the conditions. The second GEMM operation generates an encoding for the path composed by the true internal nodes, while the successive==operation returns the leaf node selected by the encoded path. Note that logical operators will broadcast B and D tensors to match the dimensions of the other operand for performing element-wise operations. Finally, the third GEMM operation maps the selected leaf node to the class label.

While this strategy is described in the context of a single tree and a classification task, it is understood that these techniques may be extended to support tree ensembles and regression tasks. For instance, for tree ensembles, the above 2-dimensional tensors are created for each tree and are batched together to produce 3-dimensional tensors. As the number of leaf nodes and internal nodes can vary among trees, the maximum number of leaf nodes and internal nodes may be selected for any tree as the tensor dimensions and the smaller tensor slices may be padded with zeros. Similarly, when the input X contains batches with multiple records, batched variants of GEMM and logical operators may be performed. For instance, during scoring, batched variants of GEMM and logical operations are invoked, and a final ReduceMean operation is performed over the batched dimension to generate the ensemble output. For regression tasks, E may be initialized with label values.

This strategy can also be further explained as follows. For instance, in accordance with this technique, the evaluation of a decision tree is cast as a series of three GEMM operations interleaved by two logical operators. In this example, m may be the number features in a record, n may be the number of internal nodes in the tree, l may be the number of leaf nodes, and c may be the number of classes.

As described above, five matrices (A, B, C, D, and E) may be created, which collectively represent the structure of the decision tree. A is a m×n matrix having A_{i,j} set to 1 if and only if the index of the feature being evaluate at the internal Node i is F j. Otherwise it is set to 0. Matrix B is a 1×n matrix with B_{1,i} set to the threshold value of the internal Node i. The input X is multiplied with A and then a less than (<) operation is performed to obtain an indicator matrix denoting which internal nodes evaluated to true. Next, the indicator matrix is multiplied by the n×1 matrix C. C_{i,j} is set to 1 if internal node corresponding to row i is on the path to leaf node corresponding to node j from root with evaluating to true. It is set to −1 if the internal node is in the path and evaluates to false. Otherwise it is set to 0. The result of this multiplication operation is then subjected to an equal condition with matrix D to obtain an indicator matrix denoting which leaf node evaluated to true. D is a 1×m matrix with D_{1,i} set to the number of internal nodes in the path to the leaf node denoted by column i from root node which evaluates to true. The resultant indicator matrix is then multiplied by matrix E to get the final result. E_{i,j} is set to 1 if and only if the leaf node corresponding to row i has class label j. FIGS. 8A-8B depicts this strategy for binary classification, but the approach can also be implemented for multi-class and regression tasks.

Strategy 2: TreeTraversal. In the above-described GEMM strategy, a degree of computational redundancy was introduced by evaluating all internal nodes and leaf nodes when only a certain of them may need evaluation. In some implementations, the computational redundancy may be reduced by mimicking a typical tree traversal, but implemented using tensor operations. In this strategy, referred to as TreeTraversal, the tree structure may be captured by five tensors: N_{L}, N_{R}, N_{F}, N_{T}, and N_{C}. The tensors are defined below in Table 2:

TABLE 2
Additional Notations used for Strategy 2

| Symbol | Description |
|---|---|
| N_{L} ∈ [symbol] ^{\|N\|} | ${N}_{{L}_{i}} = \{ \begin{matrix}LeftChild ( {N}_{i} ) , & {N}_{i} ∈ I \\ i , & Otherwise\end{matrix}$ |
| N_{R} ∈ [symbol] ^{\|N\|} | ${N}_{{R}_{i}} = \{ \begin{matrix}RightChild ( {N}_{i} ) , & {N}_{i} ∈ I \\ i , & Otherwise\end{matrix}$ |
| N_{F} ∈ [symbol] ^{\|N\|} | ${N}_{{F}_{i}} = \{ \begin{matrix}k , ( {N}_{i} ∈ I ) ⩓ ( {N}_{i} evaluates {F}_{k} ) \\ 1 , Otherwise\end{matrix}$ |
| N_{T} ∈ [symbol] ^{\|N\|} | ${N}_{{T}_{i}} = \{ \begin{matrix}ThresholdValue ( {N}_{i} ) & {N}_{i} ∈ I \\ 0 , & Otherwise\end{matrix}$ |
| N_{C} ∈ [symbol] ^{\|N\|×\|C\|} | ${N}_{{C}_{i , k}} = \{ \begin{matrix}1 , & ( {N}_{i} ∈ L ) ⩓ {N}_{i} {⟶}^{map to} {C}_{k} \\ 0 , & Otherwise\end{matrix}$ |

The same column index (last dimension) across all tensors corresponds to the same tree node. N_{L} and N_{R} capture the indices of the left and right nodes for a given node. If the node is a leaf node, these are set to the index of the given node. Similarly, N_{F} and N_{T} capture the feature index and threshold value for each node, respectively. For leaf nodes, N_{F} is set to 1 and N_{T} to 0. Finally, N_{C} captures the class label of each leaf node. For internal nodes, any values can be used, but it is set to 0 in these examples.

Given these tensors, Algorithm 2, below, presents how scoring is performed for a batch of input records X:

Algorithm 2: TreeTraversal Strategy
Input: X ∈ [symbol] ^{n × |F|}, Input records
Output: R ∈ {0, 1}^{n × |C|}, Predicted class labels

| | |
|---|---|
| /* Initialize all records to point k, with k the index of the Root node. | */ |
| T_{I} ← {k}ⁿ | // T_{I} ∈ [symbol] ⁿ |
| for i ← 1 to TREE_DEPTH do | |
| /* Find the index of the feature evaluated by the current node. | |
| Then find its value. | */ |
| T_{F} ← Gather(N_{F}, T_{I}) | // T_{F} ∈ [symbol] ⁿ |
| Tᵥ ← Gather(X, T_{f}) | // T_{V} ∈ [symbol] ⁿ |
| /* Find the threshold, left child, and right child | */ |
| T_{T} ← Gather(N_{T}, T_{I}) | // T_{T} ∈ [symbol] ⁿ |
| T_{L} ← Gather(N_{L}, T_{I}) | // T_{L} ∈ [symbol] ⁿ |
| T_{R} ← Gather(N_{R}, T_{I}) | // T_{R} ∈ [symbol] ⁿ |
| /* Perform logical evaluation. | |
| If true pick from T_{L}; else from T_{R}. | */ |
| T_{I} ← Where(T_{V} < T_{T}, T_{L}, T_{R}) | // I ∈ [symbol] ⁿ |
| end | |
| /* Find label for each leaf node | */ |
| R ← Gather(N_{C}, T_{I}) | // R ∈ [symbol] ⁿ |

As shown in Algorithm 2, Gather and Where operations are used to perform index-based slicing and conditional value selection. An index tensor T₁ is first initialized corresponding to all records in X, which points to the root node. Using T₁, Gather operation is used for the corresponding feature indices and used to Gather the corresponding feature values from X. Similarly, a Gather operation is also used for the left node indices, right node indices, and node thresholds. Using these gathered tensors, a Where operation is invoked which checks for the tree node decisions. Based on the evaluation, for each record the Where operator either returns the left child index or right child index. To perform full tree scoring, the above steps may be repeated until a leaf node is reached for all records in X. It is noted that TREE_DEPTH is a known property of the input model at compilation time, and (2) all leaf nodes are at a depth≤TREE_DEPTH, to iterate for that fixed number of iterations to ensure that all records have found their corresponding leaf node. Tensors may be created in such a way that if one of the indices reaches a leaf node before running for TREE_DEPTH iterations, the same class label will keep getting selected. At compile time, all iterations are unrolled and the for loop is removed to improve efficiency. In the case of an ensemble with multiple trees, individual tree data structures are batched into a 3-dimensional tensor with number of tree nodes set to the maximum number of nodes in any tree. However, as the number of nodes and dimensions may differ between trees, the maximum node count may be used for any tree as the dimension, and the remaining elements padded with zeros.

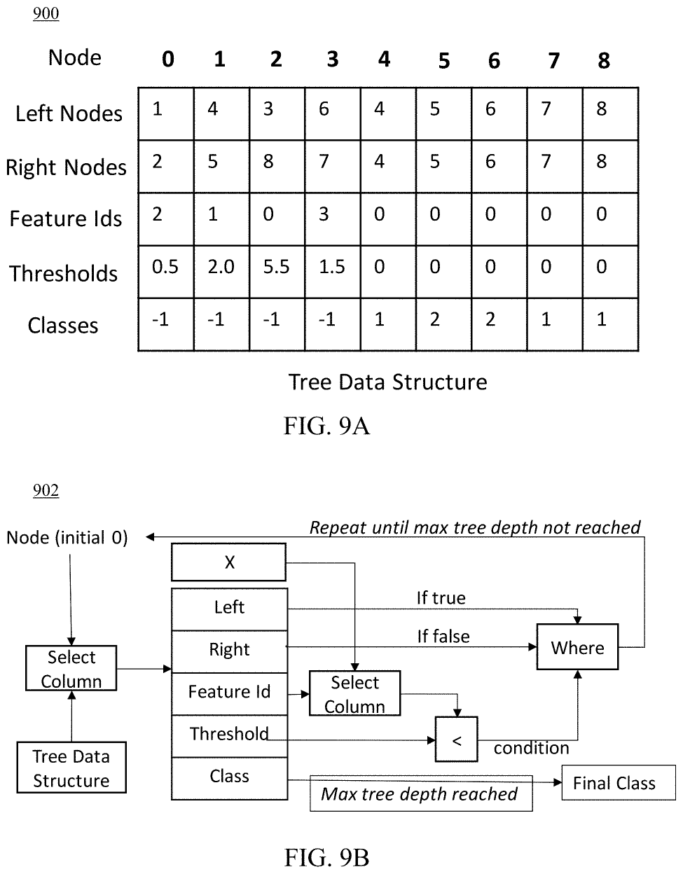

This strategy can also be further explained as follows. For instance, a high-level approach of this strategy is depicted in FIGS. 9A-9B, which show another illustrative conversion of a tree-based model, in accordance with an example embodiment. FIG. 9A depicts a matrix 900 representing an illustrative tree data structure (e.g., for the tree shown in FIG. 8A). FIG. 9B illustrates a process for converting the tree data structure into a set of tensors in accordance with this strategy. For instance, given a decision tree, a matrix maintaining the structure of the tree is created. As shown in FIG. 9A, each column in this matrix corresponds to a tree node. The matrix has five rows and each row contains different information about each tree node. The first row contains the node id of the left child and the second row contains the node id of the right child. For leaf nodes the same parent node id is repeated. The third row contains the index of the feature that is being evaluated at each node. For leaf nodes this is set to zero. The fourth row contains the threshold value and for leaf nodes again this is set to zero. The last row contains the class label corresponding to each node and for internal nodes this is set to −1 (invalid).

Given this tree data structure, starting with the initial node id of zero (root node), the corresponding column is sliced from the structure matrix. The feature id value is then selected and used to select the corresponding feature value from the input (X). A less than check is then performed to determine whether the internal node is evaluated to true or false. Based on the evaluation, either the left child id or right child id is selected as the node id for the next iteration. This operation can be performed using the Where operator available in tensor runtimes. As noted earlier, to perform the full tree inference, this process can be repeated until a leaf node is reached. However, instead of iterating in a loop, since the maximum depth of this tree is known, the loop is unrolled for a number of iterations corresponding to the maximum depth.

Strategy 3: PerfectTreeTraversal. Similar to the TreeTraversal strategy, the third strategy, referred to as PerfectTreeTraversal, may also mimic tree traversal. However, in this strategy, it is assumed that the tree (or a plurality of trees in an ensemble) is a perfect binary tree (i.e., a balanced tree). For instance, in a perfect binary tree, each internal node has exactly two children and each leaf node is at the same depth level. In some implementations, a non-perfect binary tree (i.e., an unbalanced tree) may be provided, which may be converted to a perfect binary tree in accordance with techniques described herein. For instance, a non-perfect binary tree may be obtained with a TREE_DEPTH of D, and Lₖ is a leaf node which is at a depth of Dₖ<D. To push Lₖ to a depth D, Lₖ is replaced with a perfect sub-tree of depth D−Dₖ and all the leaf nodes of the sub-tree are mapped to Cₖ (the label of the original leaf node). The decision nodes in the introduced sub-tree may then perform arbitrary comparisons as the outcome is the same along any path. By pushing all leaf nodes at depth<D to a depth of D, the original tree is transformed to a perfect tree with the same functionality.

By utilizing perfect trees, further processing improvements may be achieved. For instance, working on perfect trees may eliminate the N_{L} and N_{R} tensors, as those can be calculated analytically, which also reduces memory lookup overheads during scoring. Thus, this strategy may only create three tensors to capture the tree structure: N′_{F}, N′_{T}, and N′_{C}. These tensors are defined below in Table 3:

TABLE 3
Additional Notations used for Strategy 3

| Symbol | Description |
|---|---|
| I′ ∈ [symbol] ²^{^{D-1}}, L′ ∈ [symbol] ²^{^{D}} | Internal and leaf nodes of the transformed perfect |
| | tree ordered by level |
| N_{F}′ ∈ [symbol] ^{\|I′\|} | N_{F}_{ᵢ}′ = k [symbol] Iᵢ′ evaluates Fₖ |
| N_{T}′ ∈ [symbol] ^{\|I′\|} | N_{T}_{ᵢ}′ = ThresholdValue (Iᵢ′) |
| N_{C}′ ∈ [symbol] ^{\|L′\|×\|C\|} | ${N}_{{C}_{i , k}}^{′} = \{ \begin{matrix}1 , & {N}_{i} {⟶}^{map to} {C}_{k} \\ 0 , & Otherwise\end{matrix}$ |

The above tensors in this strategy may capture the same information as N_{F}, N_{T}, and N_{C} but have different dimensions and have a strict condition on the node order. Both N′_{F} and N′_{T} have 2^{D-1} elements and the values correspond to internal nodes generated by level order tree traversal. N′_{C} has 2^{D} elements with each corresponding to an actual leaf node from left to right order.

Given these tensors, Algorithm 3, below, may be used to explain the operation of this strategy:

| | |
|---|---|
| Algorithm 3: PerfectTreeTraversal Strategy | |
| Input: X ∈ [symbol] ^{n × \|F\|}, Input records | |
| Output: R ∈ {0, 1}^{n × \|C\|}, Predicted class labels | |
| /* Initialize all records to point to the root node | */ |
| T_{I} ← {1}ⁿ | // T_{I} ∈ [symbol] ⁿ |
| for i ← 1 to TREE_DEPTH do | |
| /* Find the index of the feature evaluated by the current node. | |
| Then find its value. | */ |
| T_{F} ← Gather(N_{F}, T_{I}) | // T_{F} ∈ [symbol] ⁿ |
| Tᵥ ← Gather(X, T_{f}) | // T_{V} ∈ [symbol] ⁿ |
| /* Find the threshold | */ |
| T_{T} ← Gather(N_{T}, T_{I}) | // T_{T} ∈ [symbol] ⁿ |
| /* Perform logical evaluation. | |
| If true pick left child; else right child. | */ |
| T_{I} ← 2 × T_{I} + Where(T_{V} < T_{T}, 0,1) | // I ∈ [symbol] ⁿ |
| end | |
| /* Find label for each leaf node | */ |
| R ← Gather(N′_{C}, T_{I}) | // R ∈ [symbol] ⁿ |

As shown in Algorithm 3, this technique is similar to Algorithm 2, but contains certain differences described below. First, the index tensor T₁ is initialized to all ones as the root node is always the first node. Second, finding the left index and right index of a node for use in a Where operation is eliminated. Instead, the Where operation returns 0 for true case and 1 for the false case. By adding this to 2×T₁ the index of the child for the next iteration is obtained. For ensembles, the maximum TREE_DEPTH of any tree as D is used for transforming trees to perfect trees. Separate are created for each tree and batched together for N′_{C}. In other words, the tree data structures corresponding to each tree are batched, and the batched variants are invoked of the tensor operations. But for N′_{F} and N′_{T}, instead of batching, the tensors are interleaved together in an order such that values corresponding to level i for all trees appear before values corresponding to level i+1 of any tree. This may result in improved memory coalescing and improved performance.

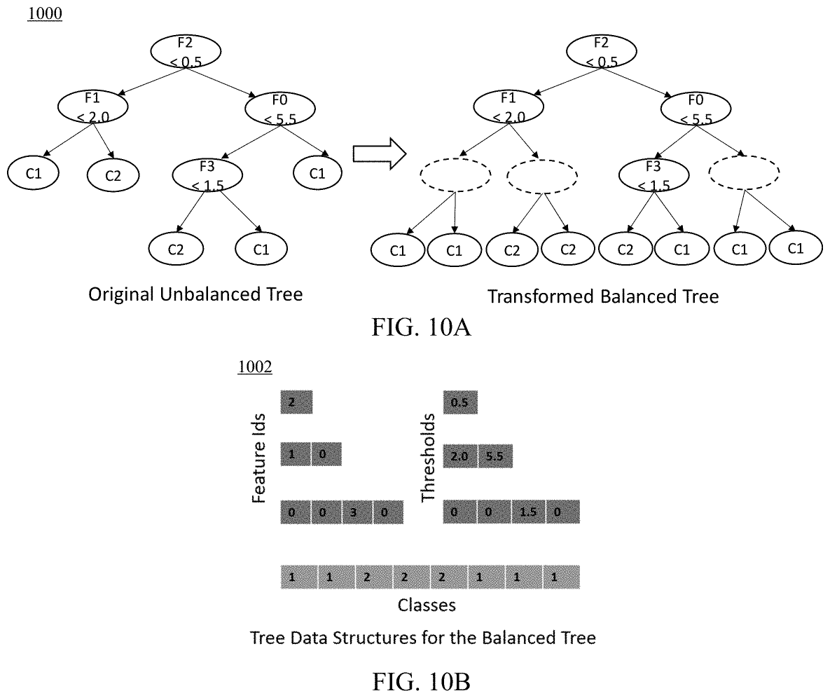

This strategy can also be further explained as follows. For instance, a high-level approach of this strategy is depicted in FIGS. 10A-10B, which show another illustrative conversion of a tree-based model, in accordance with an example embodiment. FIG. 10A depicts a conversion 1000 of an original unbalanced tree to a transformed balanced tree by inserting a plurality of dummy nodes. FIG. 10B depicts tree data structures 1002 that may be generated for the balanced tree. For instance, given a decision tree, the maximum depth of the tree may first be determined. Then, the decision tree may be transformed by incorporating dummy internal nodes and replicating the corresponding leaf nodes to make the tree a balanced tree. As described above, in this strategy, three sets of data structures (tensors) are created to maintain the structure of the decision tree: (1) indices of features checked by each internal node; (2) threshold value for each internal node; and (3) class labels. Features IDs and threshold values may be organized by depth levels. Because the tree may be a balanced tree in this strategy (or converted to a balanced tree), the look-ups for finding the left and right child node IDs of a given node may be eliminated.

### 2. Heuristics-Based Strategy Selection

For a given classical ML operator, there can be more than one compilation strategy available. In the previous sections, three such strategies for tree-based models were illustrated. Neural network model converter 702 may select different strategies in different situations based on the input and model structure. For instance, the GEMM strategy may be used for relatively smaller decision trees, due at least in part to increased redundant computations when the trees are bigger. For instance, the GEMM strategy may perform O(2^{D}) (D is the height of the tree) computations whereas the original algorithmic operator may only perform O(D) comparisons. Nevertheless, with small batch sizes or a large number of smaller trees, the GEMM strategy may be optimal for performance on certain hardware where GEMM operations can run highly efficiently. With large batch sizes and taller trees, TreeTraversal techniques typically may be more suitable, and PerfectTreeTraversal may provide for even more improved performance compared to TreeTraversal due to the reduced number of index lookups and improved coalesced memory accesses. However, if the trees are relatively deep, TreeTraversal may be desired due to an increased O(2^{D}) memory footprint of the associated data structures with the PerfectTreeTraversal strategy.

The point where the GEMM strategy may have improved performance over the TreeTraversal and PerfectTreeTraversal strategies may be determined by the characteristics of the tree model (e.g., number of trees, maximum depth of the trees), runtime statistics (e.g., batch size), and the underlying hardware (e.g., CPUs, GPUs). For instance, on CPUs, the GEMM strategy may have improved performance for shallow trees (≤3 on CPU, ≤10 on GPU) or for scoring with smaller batch sizes. For tall trees, using PerfectTreeTraversal when D≤10 may be preferred, while TreeTraversal may be preferred for taller trees (D>10). Such heuristics-based selection may be preset in neural network model converter 702 in some implementations. In other implementations, these heuristics may be overridden by a user.

### 3. Optimizations

In addition to heuristics, techniques described herein also utilize runtime-independent optimizations at the optimizer level and runtime-specific optimizations at the DAG compiler level. Optimizations, including runtime-independent optimizations, can be broadly classified into several categories.

DAG transformations. In classical ML pipelines there are opportunities to optimize the end-to-end pipeline through transformation rules, which are typically applicable only in the prediction setting. Feature selection is an operation that is often used as the final featurization step as it may reduce over-fitting and improves the accuracy of the ML model. However, during scoring, it can be pushed down in the pipeline to avoid redundant computations such as scaling and one-hot encoding for discarded features or even reading the feature at all. This idea is similar to the concept of projection push-down in relation query processing but through user-defined table functions.

For example consider a pipeline in which before features are fed to a linear model, a feature selection operator is used to discard not useful features. However, during prediction time this operator can be pushed down, similarly to projection push-down in databases. This may avoid redundant computations such as scaling and one-hot encoding for discarded features, or even reading the feature at all.

For operators such as feature scaling, which performs 1-to-1 transformations, selection push-down can also implemented. However, for 1-to-n and n-to-1 operators such as one-hot encoding and polynomial featurizer, the operator may need to absorb the feature selection. After absorbing, it is possible that some of the original features can still be discarded as they are not used. For example, say onehot encoding is applied on a categorical feature column which has a vocabulary size of 10, but 4 of those features are discarded by the feature selector. In such cases, such features can be removed from the vocabulary. After such absorbing, it is possible that some of the input features can still be discarded as they are not used at all, which may allow the feature selection to be pushed even further.

In some examples, even if the original pipeline does not have a feature selection operator, it may be possible to inject one and then push it down to avoid redundant computations. L1 regularization (Lasso) is a typical example where feature selection is implicitly performed. This idea can be extended to tree-based models to prune the features that are not used as decision variables. In both of these examples, the ML model may be updated to take into account the pruned features. For linear models, the zero weights are pruned, and for tree models, the indices of the decision variables are updated.

Cross-operator optimizations. Techniques described herein may also implement several cross-operator optimizations. This includes operator fusion and operator batching optimizations. For example a scaling operator and logistic regression model in a ML pipeline may be merged into one operator which performs a single GEMM operation. In another example, a stacked ensemble model may be composed of logistic regression, linear SVM, and a Bernoulli Naive Bayes models. While these models are conceptually different, during inference time each of them may be performing a GEMM operation. Thus, it is possible to batch them together into one GEMM operation in order to reduce the overheads.

Cost-based compilation target selection. When compiling classical ML pipelines, for a given high-level operator there may be more than one compilation target. For example, in the case of decision tree-based models, neural network model converter 702 may implement any of the described compilation strategies, or any other compilation strategy as will be appreciated to those skilled in the relevant arts. In practice, the selection of the compilation strategy to use may be different based on situations depending on the input model structure. For example, one strategy (GEMM) to implement tree inference is to compute all internal decisions at once. However, as the size of the decision trees get bigger, this strategy may comprise certain inefficiencies due to redundant computations. With this strategy, O(2^{h}) (h is the height of the tree) computations are performed, whereas the original algorithmic operator may perform only O(h) comparisons. Nevertheless, such a strategy may still lead to improved performance up to a certain depth level, such as on certain hardware where GEMM operations may run highly efficiently. Thus, techniques described herein may also use a cost model for compilation target selection, similar to relational data management systems, to reduce resource utilization.

Algebraic Rewrites. Neural network model converter 702 may also be configured to rewrite several operators that perform linear algebra operations into a single GEMM operation. For instance, consider an example in which a pipeline trains a logistic regression model and has feature scaling and matrix decomposition (e.g., PCA) as featurization steps. The pipeline may be algebraically represented as the left hand side (LHS) of the equation:

$$sigmoid ( ( ( \frac{X - α}{β} ) \cdot {W}_{PCA} ) \cdot {W}_{LR} + {B}_{LR} ) = sigmoid ( X \cdot W + B )$$

The parentheses of the LHS of this equation may capture the order in which the operators were trained and may require performing five tensor operations: two element-wise operations for scaling; two GEMM operations for matrix decomposition and logistic regression; and a final sigmoid operation for logistic regression. In such an example, it is possible to use linear algebra properties and represent the same pipeline using two operations as shown in RHS, where tensor W and B can be pre-computed and used during scoring. Such patterns are typically present in ML techniques such as scaling, matrix decomposition, and linear models. Example embodiments described herein may utilize such patterns and potential rewrites during optimization to further improve performance and/or reduce resource utilization.

Runtime optimizations. As described earlier, certain runtime-dependent optimizations may also be implemented in accordance with techniques disclosed herein. For instance, low-precision inference (e.g., in TensorRT) and optimized kernel generation (e.g., TVM) may be implemented as runtime-specific optimizations to further improve performance and/or reduce resource utilization.

### 4. Summary of Additional Techniques

This section explores additional techniques that may be used across many ML operators to improve the efficiency when compile them into tensor computations.

Exploiting Automatic Broadcasting. Broadcasting is the process of making two tensors shape compatible for element-wise operations. Two tensors are said to be shape compatible if each dimension pair is the same or one of them is 1. At execution time, tensor operations implicitly repeat the size 1 dimensions to match the size of the other tensor, without allocating memory for these expansions. In neural network model converter 702, this feature may be used to execute some computations over multiple inputs. For example, consider performing a one-hot encoding operation over column Xᵢ∈ [symbol] ⁿ with a vocabulary V∈ [symbol] ⁿ. In order to implement this using tensor computations, a Reshape is performed on Xᵢ to [n, 1] and V to [1, m]. A calculation is performed where R=Equal(X, V), R∈{0,1}^{n×m}. The Reshape operations are may be considered free because they only modify the metadata of the original tensor. However, this approach performs redundant comparisons as it checks the feature values from all records against all vocabulary values, which is different from an imperative approach.

Minimize Operator Invocations. Given two approaches to implement an ML operator, it was observed that often times, picking the one which invokes fewer operators outperforms the other—even if it performs extra computations. For instance, consider a featurizer that generates feature interactions. Given an input X∈ [symbol] ^{n×d}, with d=|F|, it generates a transformed output R∈

$${ℝ}^{n \times \frac{d \cdot ( d + 1 )}{2}} ,$$

with Rᵢ=[X_{i,1}², . . . , X_{i,d}², X_{i,1}X_{i,2}, . . . X_{i,d-1}X_{i,d}]. One way to implement this operator is to compute each new feature separately by first gathering the corresponding input feature columns, perform an element-wise multiplication, and concatenate all new features. However, this approach requires performing d²+d+1 operations and hence may result in inefficiencies due to high operator scheduling overheads. Alternatively, the same operator could be implemented as follows. First, X may be reshaped into ′∈ [symbol] ^{n×d×1} and X″∈ [symbol] ^{n×1×d}. Then, a batched GEMM is performed using these inputs, which will create R∈ [symbol] ^{n×d×d}. Finally, a Reshape is performed for R′ to R″∈ [symbol] ^{n×d}^{²}. It is noted that each row in R″ has all the values of the corresponding row in R, but in a different order. It also has some redundant values due to commutativity of multiplication (i.e., xᵢxⱼ=xⱼxᵢ). Hence, a final Gather is performed to extract the features in the required order, and generate R. While this approach may perform roughly twice the computations than the previous approach and also increases the peak memory footprint roughly by a factor of two, it enables the feature interaction operator to be implemented in two tensor operations, and therefore may execute with increased efficiency on tensor runtimes.

Reducing Generation of Large Intermediate Results. While exploiting automatic broadcasting may be useful in many instances, in certain cases it can have some inefficiencies due to the materialization of large intermediate tensors. For instance, consider the Euclidean distance matrix calculation, which is a sub-operation in many ML operators (e.g., SVMs, KNearestNeighbor). Given two tensors X∈ [symbol] ^{n×d} and Y∈^{m×d} the tensor D∈ [symbol] ^{n×m} may be calculated, where D_{i,j}=∥Xᵢ−Yⱼ∥₂². Implementing this using broadcasting may be performed by first reshaping X to X′∈ [symbol] ^{n×1×d}, Y to Y′∈ [symbol] ^{1×m×d}, calculating (X′−Y′)∈ [symbol] ^{n×m×d}, and performing a final sum reduction over the last dimension. This approach may result in an increased size by a factor of d in intermediate tensors. Alternatively, the quadratic expansion of D_{i,j}=∥Xᵢ∥₂²+∥Yⱼ∥₂²−2·XᵢYⱼ^{T} may be used, and the individual terms calculated separately, which can reduce the generation of a large intermediate tensor.

Fixed Length Restriction on String Features. In some instances, arbitrary lengths of string features may be present. Strings are commonly used for categorical features in traditional ML datasets, and operators like one-hot encoding and feature hashing in traditional ML tools natively support string features. To support string features, neural network model converter 702 may impose a fixed length restriction with the length being determined by the maximum size of any string in the vocabulary. Vocabularies may be generated during training and can be accessed at compile time by network model converter 702. Fixed length strings can then be encoded into a particular data type (e.g., an int8 data type) and processed by tensor runtimes.

### E. Concluding Remarks

Prediction serving systems for DNNs are maturing rapidly, whereas prediction serving for classical ML pipeline is still limited to ad-hoc solutions, or poor performance and limited portability. As described herein, techniques are provide for compiling full pipelines (e.g., various types of data featurizers and traditional ML models) into tensor operations such that DNN prediction serving runtimes can be directly used for scoring classical ML models end-to-end. In this manner, models may be executed with improved performance, thereby predictions to be generated with a higher frequency.

### IV. Example Computer System Implementation

Computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, runtime optimizer 318, neural network model converter 702, flowchart 200, flowchart 400, flowchart 500, and/or flowchart 600 may be implemented in hardware, or hardware combined with one or both of software and/or firmware. For example, computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, runtime optimizer 318, neural network model converter 702, flowchart 200, flowchart 400, flowchart 500, and/or flowchart 600 may be implemented as computer program code/instructions configured to be executed in one or more processors and stored in a computer readable storage medium.

Alternatively, computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, runtime optimizer 318, neural network model converter 702, flowchart 200, flowchart 400, flowchart 500, and/or flowchart 600 may be implemented as hardware logic/electrical circuitry.

For instance, in an embodiment, one or more, in any combination, of computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, runtime optimizer 318, neural network model converter 702, flowchart 200, flowchart 400, flowchart 500, and/or flowchart 600 may be implemented together in a system on a chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

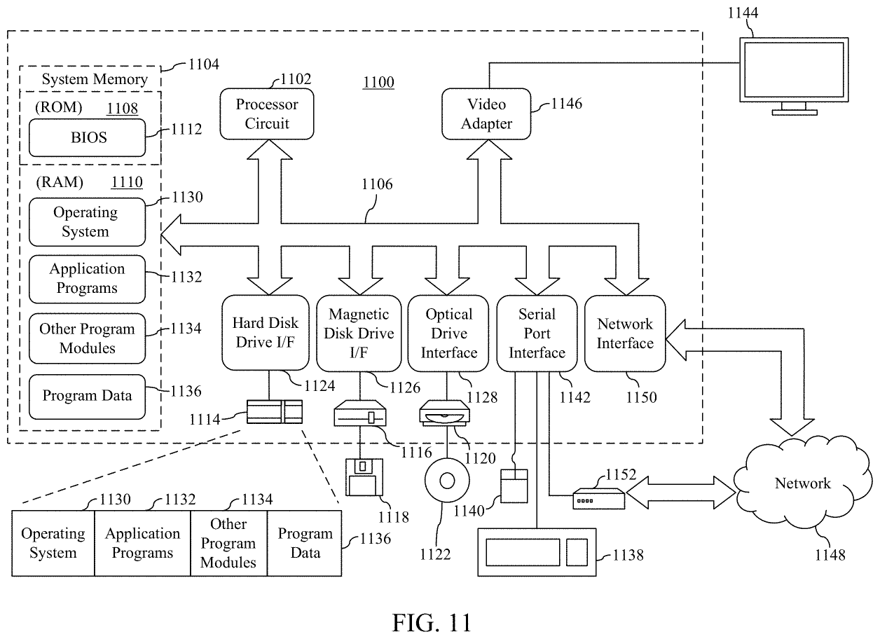

FIG. 11 depicts an exemplary implementation of a computing device 1100 in which embodiments may be implemented. For example, computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, runtime optimizer 318, neural network model converter 702, flowchart 200, flowchart 400, flowchart 500, and/or flowchart 600 (and/or any of the steps of flowcharts 200, 400, 500, and 600 described therein) may be implemented in one or more computing devices similar to computing device 1100 in stationary or mobile computer embodiments, including one or more features of computing device 1100 and/or alternative features. The description of computing device 1100 provided herein is provided for purposes of illustration, and is not intended to be limiting. Embodiments may be implemented in further types of computer systems, as would be known to persons skilled in the relevant art(s).

As shown in FIG. 11, computing device 1100 includes one or more processors, referred to as processor circuit 1102, a system memory 1104, and a bus 1106 that couples various system components including system memory 1104 to processor circuit 1102. Processor circuit 1102 is an electrical and/or optical circuit implemented in one or more physical hardware electrical circuit device elements and/or integrated circuit devices (semiconductor material chips or dies) as a central processing unit (CPU), a graphics processing unit (GPU), a microcontroller, a microprocessor, and/or other physical hardware processor circuit. Processor circuit 1102 may execute program code stored in a computer readable medium, such as program code of operating system 1130, application programs 1132, other programs 1134, etc. Bus 1106 represents one or more of any of several types of bus structures, including a memory bus or memory controller, a peripheral bus, an accelerated graphics port, and a processor or local bus using any of a variety of bus architectures. System memory 1104 includes read only memory (ROM) 1108 and random-access memory (RAM) 1110. A basic input/output system 1112 (BIOS) is stored in ROM 1108.

Computing device 1100 also has one or more of the following drives: a hard disk drive 1114 for reading from and writing to a hard disk, a magnetic disk drive 1116 for reading from or writing to a removable magnetic disk 1118, and an optical disk drive 1120 for reading from or writing to a removable optical disk 1122 such as a CD ROM, DVD ROM, or other optical media. Hard disk drive 1114, magnetic disk drive 1116, and optical disk drive 1120 are connected to bus 1106 by a hard disk drive interface 1124, a magnetic disk drive interface 1126, and an optical drive interface 1128, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1130, one or more application programs 1132, other programs 1134, and program data 1136. Application programs 1132 or other programs 1134 may include, for example, computer program logic (e.g., computer program code or instructions) for implementing any of the features of computing device 102, neural network model converter 104, neural network model 106, neural network pipeline 108, neural network framework 110, input data 112, prediction 114, ML pipeline 116, ML model 118, ML pipeline parser 302, ML operator set 304, neural network operator set 306, neural network representation 308, neural network optimizer 310, optimized neural network representation 312, tensor set provider 314, runtime optimizer 318, neural network model converter 702, flowchart 200, flowchart 400, flowchart 500, flowchart 600, and/or further embodiments described herein.

A user may enter commands and information into computing device 1100 through input devices such as keyboard 1138 and pointing device 1140. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1102 through a serial port interface 1142 that is coupled to bus 1106, but may be connected by other interfaces, such as a parallel port, game port, or a universal serial bus (USB).

A display screen 1144 is also connected to bus 1106 via an interface, such as a video adapter 1146. Display screen 1144 may be external to, or incorporated in computing device 1100. Display screen 1144 may display information, as well as being a user interface for receiving user commands and/or other information (e.g., by touch, finger gestures, virtual keyboard, etc.). In addition to display screen 1144, computing device 1100 may include other peripheral output devices (not shown) such as speakers and printers.

Computing device 1100 is connected to a network 1148 (e.g., the Internet) through an adaptor or network interface 1150, a modem 1152, or other means for establishing communications over the network. Modem 1152, which may be internal or external, may be connected to bus 1106 via serial port interface 1142, as shown in FIG. 11, or may be connected to bus 1106 using another interface type, including a parallel interface.

As used herein, the terms “computer program medium,” “computer-readable medium,” and “computer-readable storage medium” are used to refer to physical hardware media such as the hard disk associated with hard disk drive 1114, removable magnetic disk 1118, removable optical disk 1122, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1132 and other programs 1134) may be stored on the hard disk, magnetic disk, optical disk, ROM, RAM, or other hardware storage medium. Such computer programs may also be received via network interface 1150, serial port interface 1142, or any other interface type. Such computer programs, when executed or loaded by an application, enable computing device 1100 to implement features of embodiments discussed herein. Accordingly, such computer programs represent controllers of the computing device 1100.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. Further Example Embodiments

A system for generating a neural network model is disclosed herein. The system includes at least one processor circuit; and at least one memory that stores program code configured to be executed by the at least one processor circuit, the program code comprising: a machine-learning (ML) pipeline parser configured to: identify a set of ML operators for a previously trained ML pipeline, map the set of ML operators to a set of neural network operators, and generate a first neural network representation using the set of neural network operators; a neural network optimizer configured to perform an optimization on the first neural network representation to generate a second neural network representation; and a tensor set provider configured to output a set of tensor operations based on the second neural network representation for execution on a neural network framework.

In one implementation of the foregoing system, the previously trained ML pipeline comprises at least one of a decision tree model or a linear model.

In another implementation of the foregoing system, the ML parser is further configured to: determine that the previously trained ML pipeline comprises an unbalanced tree, and insert one or more dummy nodes to convert the unbalanced tree to a balanced tree.

In another implementation of the foregoing system, a total number of operators in the set of neural network operators is less than a total number of operators in the set of ML operators.

In another implementation of the foregoing system, the ML pipeline parser is configured to generate the first neural network representation by generating a set of tensors based on a structure of the previously trained ML pipeline.

In another implementation of the foregoing system, the ML pipeline parser is configured to generate the first neural network representation without performing a backpropagation of parameters.

In another implementation of the foregoing system, the system further includes a runtime optimizer configured to perform an optimization on the set of tensor operations prior to execution on the neural network framework.

A method for generating a neural network model is disclosed herein. The method includes identifying a set of ML operators for a previously trained ML pipeline; mapping the set of ML operators to a set of neural network operators; generating a first neural network representation using the set of neural network operators; performing an optimization on the first neural network representation to generate a second neural network representation; and outputting a set of tensor operations based on the second neural network representation for execution on a neural network framework.

In one implementation of the foregoing method, the previously trained ML pipeline comprises at least one of a decision tree model or a linear model.

In another implementation of the foregoing method, the method further includes: determining that the previously trained ML pipeline comprises an unbalanced tree; and inserting one or more dummy nodes to convert the unbalanced tree to a balanced tree.

In another implementation of the foregoing method, a total number of operators in the set of neural network operators is less than a total number of operators in the set of ML operators.

In another implementation of the foregoing method, the generating the first neural network representation comprises generating a set of tensors based on a structure of the previously trained ML pipeline.

In another implementation of the foregoing method, the generating the first neural network representation is performed without a backpropagation of parameters.

In another implementation of the foregoing method, the method further includes performing an optimization on the set of tensor operations prior to execution on the neural network framework.

A computer-readable storage medium is disclosed herein. The computer-readable storage medium has program instructions recorded thereon that, when executed by at least one processor of a computing device, perform a method, the method comprising: identifying a set of ML operators for a previously trained ML pipeline; mapping the set of ML operators to a set of neural network operators; generating a first neural network representation using the set of neural network operators; performing an optimization on the first neural network representation to generate a second neural network representation; and outputting a set of tensor operations based on the second neural network representation for execution on a neural network framework.

In another implementation of the foregoing computer-readable storage medium, the previously trained ML pipeline comprises at least one of a decision tree model or a linear model.

In another implementation of the foregoing computer-readable storage medium, the method further comprises: determining that the previously trained ML pipeline comprises an unbalanced tree; and inserting one or more dummy nodes to convert the unbalanced tree to a balanced tree.

In another implementation of the foregoing computer-readable storage medium, a total number of operators in the set of neural network operators is less than a total number of operators in the set of ML operators.

In another implementation of the foregoing computer-readable storage medium, the generating the first neural network representation comprises generating a set of tensors based on a structure of the previously trained ML pipeline.

In another implementation of the foregoing computer-readable storage medium, the generating the first neural network representation is performed without a backpropagation of parameters.

### VI. Conclusion

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A system for generating a neural network model, the system comprising:
at least one processor circuit; and
at least one memory that stores program code configured to be executed by the at least one processor circuit, the program code comprising:
a machine-learning (ML) pipeline parser configured to:
identify a set of ML operators for a previously trained ML pipeline,
map the set of ML operators to a set of neural network operators, and
generate a first neural network representation using the set of neural network operators;
a neural network optimizer configured to perform an optimization on the first neural network representation to generate a second neural network representation; and
a tensor set provider configured to output a set of tensor operations based on the second neural network representation for execution on a neural network framework.

2. The system of claim 1, wherein the previously trained ML pipeline comprises at least one of a decision tree model or a linear model.

3. The system of claim 1, wherein the ML parser is further configured to:
determine that the previously trained ML pipeline comprises an unbalanced tree, and
insert one or more dummy nodes to convert the unbalanced tree to a balanced tree.

4. The system of claim 1, wherein a total number of operators in the set of neural network operators is less than a total number of operators in the set of ML operators.

5. The system of claim 1, wherein the ML pipeline parser is configured to generate the first neural network representation by generating a set of tensors based on a structure of the previously trained ML pipeline.

6. The system of claim 1, wherein the ML pipeline parser is configured to generate the first neural network representation without performing a backpropagation of parameters.

7. The system of claim 1, further comprising;
a runtime optimizer configured to perform an optimization on the set of tensor operations prior to execution on the neural network framework.

8. A method for generating a neural network model, the method comprising:
identifying a set of ML operators for a previously trained ML pipeline;
mapping the set of ML operators to a set of neural network operators;
generating a first neural network representation using the set of neural network operators;
performing an optimization on the first neural network representation to generate a second neural network representation; and
outputting a set of tensor operations based on the second neural network representation for execution on a neural network framework.

9. The method of claim 8, wherein the previously trained ML pipeline comprises at least one of a decision tree model or a linear model.

10. The method of claim 8, further comprising:
determining that the previously trained ML pipeline comprises an unbalanced tree; and
inserting one or more dummy nodes to convert the unbalanced tree to a balanced tree.

11. The method of claim 8, wherein a total number of operators in the set of neural network operators is less than a total number of operators in the set of ML operators.

12. The method of claim 8, wherein the generating the first neural network representation comprises generating a set of tensors based on a structure of the previously trained ML pipeline.

13. The method of claim 8, wherein the generating the first neural network representation is performed without a backpropagation of parameters.

14. The method of claim 8, further comprising:
performing an optimization on the set of tensor operations prior to execution on the neural network framework.

15. A computer-readable storage medium having program instructions recorded thereon that, when executed by at least one processor of a computing device, perform a method, the method comprising:
identifying a set of ML operators for a previously trained ML pipeline;
mapping the set of ML operators to a set of neural network operators;
generating a first neural network representation using the set of neural network operators;
performing an optimization on the first neural network representation to generate a second neural network representation; and
outputting a set of tensor operations based on the second neural network representation for execution on a neural network framework.

16. The computer-readable storage medium of claim 15, wherein the previously trained ML pipeline comprises at least one of a decision tree model or a linear model.

17. The computer-readable storage medium of claim 15, wherein the method further comprises:
determining that the previously trained ML pipeline comprises an unbalanced tree; and
inserting one or more dummy nodes to convert the unbalanced tree to a balanced tree.

18. The computer-readable storage medium of claim 15, wherein a total number of operators in the set of neural network operators is less than a total number of operators in the set of ML operators.

19. The computer-readable storage medium of claim 15, wherein the generating the first neural network representation comprises generating a set of tensors based on a structure of the previously trained ML pipeline.

20. The computer-readable storage medium of claim 15, wherein the generating the first neural network representation is performed without a backpropagation of parameters.
